(19) United States
(12) Patent Application Publication
(10) Pub. No.: US 2026/0312767 A1
(43) Pub. Date: Oct. 8, 2026

(54) DYNAMIC PRECODER GROUPINGS

(71) Applicant: QUALCOMM Incorporated, San Diego, CA (US)

(72) Inventors: Aviv REGEV, Tel Aviv (IL); Ronen SHAKED, Kfar Saba (IL); Amit MOSES, Givatayim (IL)

(21) Appl. No.: 19/169,988

(22) Filed: Apr. 3, 2025

(51) Int. Cl. H04L 5/00; H04B 7/08; H04W 72/231; H04W 72/51

(52) U.S. Cl. CPC H04L 5/0053; H04B 7/088; H04W 72/231; H04W 72/51

(57) ABSTRACT

Various aspects of the present disclosure generally relate to wireless communication. In some aspects, a user equipment (UE) may receive, from a network node, configuration information indicating a first grouping of a first subset of a plurality of transmission streams with a first subset of a plurality of antennas at the UE and a second grouping of a second subset of the plurality of transmission streams with a second subset of the plurality of antennas. The UE may receive a communication via the plurality of transmission streams, demodulate the first subset of the plurality of transmission streams received by the first subset of the antennas based on the configuration information, and demodulate the second subset of the plurality of transmission streams received by the second subset of the antennas based on the configuration information. Numerous other aspects are described.

### FIELD OF THE DISCLOSURE

Aspects of the present disclosure generally relate to wireless communication and specifically relate to techniques, apparatuses, and methods associated with dynamic precoder groupings.

### DESCRIPTION OF THE RELATED TECHNOLOGY

Wireless communication systems are widely deployed to provide various services, which may involve carrying or supporting voice, text, other messaging, video, data, or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, or device transmit power, among other examples). Such multiple-access RATs are supported by technological advancements that have been adopted in various telecommunication standards, which define common protocols that enable different wireless communication devices to communicate on a local, municipal, national, regional, or global level. An example telecommunication standard is New Radio (NR). NR, which also may be referred to as 5G, is part of a continuous mobile broadband evolution promulgated by the Third Generation Partnership Project (3GPP). As the demand for connectivity continues to increase, further improvements in NR may be implemented, and other RATs, such as 6G and beyond, may be introduced to enable new applications and facilitate new use cases.

In some wireless communication networks, a network node may be capable of transmitting multiple transmissions streams in a downlink communication. For example, a network node may be capable of transmitting a downlink communication that includes four or eight transmission streams in a downlink communication. A user equipment (UE) may also be equipped with multiple receive (Rx) antennas, which may enable the UE to receive the multiple transmission streams of the downlink communication.

### SUMMARY

Some aspects described herein relate to a method of wireless communication performed by a user equipment (UE). The method may include receiving, from a network node, configuration information indicating a first grouping of a first subset of a plurality of transmission streams with a first subset of a plurality of antennas at the UE and a second grouping of a second subset of the plurality of transmission streams with a second subset of the plurality of antennas. The method may include receiving, from the network node using the plurality of antennas, a communication via the plurality of transmission streams. The method may include demodulating the first subset of the plurality of transmission streams received by the first subset of the antennas based at least in part on the configuration information. The method may include demodulating the second subset of the plurality of transmission streams received by the second subset of the antennas based at least in part on the configuration information.

Some aspects described herein relate to a method of wireless communication performed by a network node. The method may include transmitting, to a UE, configuration information indicating a first grouping of a first subset of a plurality of transmission streams with a first subset of a plurality of antennas at the UE and a second grouping of a second subset of the plurality of transmission streams with a second subset of the plurality of antennas. The method may include applying a precoder to a signal to generate a communication in accordance with the configuration information. The method may include transmitting, to the UE using the plurality of antennas, the communication via the plurality of transmission streams.

Some aspects described herein relate to a non-transitory computer-readable medium that stores a set of instructions for wireless communication by a UE. The set of instructions, when executed by one or more processors of the UE, may cause the UE to receive, from a network node, configuration information indicating a first grouping of a first subset of a plurality of transmission streams with a first subset of a plurality of antennas at the UE and a second grouping of a second subset of the plurality of transmission streams with a second subset of the plurality of antennas. The set of instructions, when executed by one or more processors of the UE, may cause the UE to receive, from the network node using the plurality of antennas, a communication via the plurality of transmission streams. The set of instructions, when executed by one or more processors of the UE, may cause the UE to demodulate the first subset of the plurality of transmission streams received by the first subset of the antennas based at least in part on the configuration information. The set of instructions, when executed by one or more processors of the UE, may cause the UE to demodulate the second subset of the plurality of transmission streams received by the second subset of the antennas based at least in part on the configuration information.

Some aspects described herein relate to a non-transitory computer-readable medium that stores a set of instructions for wireless communication by a network node. The set of instructions, when executed by one or more processors of the network node, may cause the network node to transmit, to a UE, configuration information indicating a first grouping of a first subset of a plurality of transmission streams with a first subset of a plurality of antennas at the UE and a second grouping of a second subset of the plurality of transmission streams with a second subset of the plurality of antennas. The set of instructions, when executed by one or more processors of the network node, may cause the network node to apply a precoder to a signal to generate a communication in accordance with the configuration information. The set of instructions, when executed by one or more processors of the network node, may cause the network node to transmit, to the UE using the plurality of antennas, the communication via the plurality of transmission streams.

Some aspects described herein relate to a UE. The UE may include a processing system. The processing system may include one or more processors and one or more code-storing memories coupled with the one or more processors. The processing system may be configured to cause the UE to receive, from a network node, configuration information indicating a first grouping of a first subset of a plurality of transmission streams with a first subset of a plurality of antennas at the UE and a second grouping of a second subset of the plurality of transmission streams with a second subset of the plurality of antennas. The processing system may be configured to cause the UE to receive, from the network node using the plurality of antennas, a communication via the plurality of transmission streams. The processing system may be configured to cause the UE to demodulate the first subset of the plurality of transmission streams received by the first subset of the antennas based at least in part on the configuration information. The processing system may be configured to cause the UE to demodulate the second subset of the plurality of transmission streams received by the second subset of the antennas based at least in part on the configuration information.

Some aspects described herein relate to a network node. The network node may include a processing system. The processing system may include one or more processors and one or more code-storing memories coupled with the one or more processors. The processing system may be configured to cause the network node to transmit, to a UE, configuration information indicating a first grouping of a first subset of a plurality of transmission streams with a first subset of a plurality of antennas at the UE and a second grouping of a second subset of the plurality of transmission streams with a second subset of the plurality of antennas. The processing system may be configured to cause the network node to apply a precoder to a signal to generate a communication in accordance with the configuration information. The processing system may be configured to cause the network node to transmit, to the UE using the plurality of antennas, the communication via the plurality of transmission streams.

Some aspects described herein relate to an apparatus for wireless communication. The apparatus may include means for receiving, from a network node, configuration information indicating a first grouping of a first subset of a plurality of transmission streams with a first subset of a plurality of antennas at the apparatus and a second grouping of a second subset of the plurality of transmission streams with a second subset of the plurality of antennas. The apparatus may include means for receiving, from the network node using the plurality of antennas, a communication via the plurality of transmission streams. The apparatus may include means for demodulating the first subset of the plurality of transmission streams received by the first subset of the antennas based at least in part on the configuration information. The apparatus may include means for demodulating the second subset of the plurality of transmission streams received by the second subset of the antennas based at least in part on the configuration information.

Some aspects described herein relate to an apparatus for wireless communication. The apparatus may include means for transmitting, to a UE, configuration information indicating a first grouping of a first subset of a plurality of transmission streams with a first subset of a plurality of antennas at the UE and a second grouping of a second subset of the plurality of transmission streams with a second subset of the plurality of antennas. The apparatus may include means for applying a precoder to a signal to generate a communication in accordance with the configuration information. The apparatus may include means for transmitting, to the UE using the plurality of antennas, the communication via the plurality of transmission streams.

The systems, methods, and devices of this disclosure each have several innovative aspects, no single one of which is solely responsible for the desirable attributes disclosed herein.

Aspects of the present disclosure may generally be implemented by or as a method, apparatus, system, computer program product, non-transitory computer-readable medium, user equipment, network node, wireless communication device, or processing system as substantially described in the Detailed Description with reference to, and as illustrated by, the accompanying drawings. Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 is a diagram illustrating an example of a wireless communication network.

FIGS. 2A, 2B, and 2C are diagrams illustrating examples of precoded channels that are associated with dynamic precoder groupings.

FIGS. 3 and 4 are diagrams illustrating examples associated with dynamic precoder groupings.

FIG. 5 is a diagram illustrating an example process performed, for example, at a user equipment (UE) or an apparatus of a UE.

FIG. 6 is a diagram illustrating an example process performed, for example, at a network node or an apparatus of a network node.

FIG. 7 is a diagram of an example apparatus for wireless communication.

FIG. 8 is a diagram of an example apparatus for wireless communication.

### DETAILED DESCRIPTION

In some wireless communication networks, network nodes may be capable of transmitting multiple transmissions streams in a downlink communication. For example, a network node may be capable of transmitting a downlink communication that includes four or eight transmission streams in a downlink communication. A user equipment (UE) may also be equipped with multiple receive (Rx) antennas, which may enable the UE to receive the multiple transmission streams of the downlink communication. For example, a UE may be equipped with eight Rx antennas, which may enable the UE to receive a downlink communication that includes eight transmission streams. However, despite including the multiple Rx antennas, some UEs may not have a capability of demodulating the same quantity of transmission streams concurrently. For example, a UE that includes eight Rx antennas may only be capable of demodulating up to four transmission streams concurrently. Accordingly, the UE may not be capable of demodulating a downlink communication that includes eight transmission streams (for example) and may instead be limited to demodulating downlink communications that include four or fewer transmission streams.

Various aspects relate generally to enabling a UE that has limited demodulation capabilities to receive downlink communications with multiple transmission streams. Some aspects more specifically relate to a network node precoding a downlink communication that includes multiple transmission streams using a split precoder, which splits the multiple transmission streams into two subsets that a receiving wireless communication device (e.g., a UE) may demodulate independently. Accordingly, a UE that is capable of receiving a first quantity of transmission streams but is only capable of demodulating a second quantity, that is fewer than the first quantity, of transmission streams concurrently may receive the downlink communication and perform two demodulation operations (e.g., on the two subsets of transmission streams) to demodulate the downlink communication. For example, a UE that is equipped with eight Rx antennas and is capable of demodulating up to four transmission streams concurrently may receive a communication from the network node that includes eight transmission streams, demodulate a first subset of the transmission streams (e.g., that includes four transmission streams received by four of the Rx antennas), and separately demodulate a second subset of the transmission streams (e.g., that includes the other four transmission streams received by the other four Rx antennas of the UE).

In some aspects, the network node may dynamically determine a precoder to apply to the signal to generate the communication based on the capability of the UE, channel conditions, and information related to the Rx antennas at the UE (such as antenna correlation values or an autocovariance matrix with the Rx antennas). Then the network node may transmit, to the UE, configuration information indicating a first grouping of a first subset of transmission streams with a first subset of the Rx antennas and a second grouping of a second subset of transmission streams with a second subset of the Rx antennas. The UE may then perform two demodulation operations on communications received from the network node in accordance with the configuration information. Accordingly, the network node may dynamically configure precoder groupings of transmission streams, and the UE may perform multiple demodulations on received communications in accordance with the dynamic configurations.

Particular aspects of the subject matter described in this disclosure can be implemented to realize one or more of the following potential technical advantages. The described techniques may enable UEs to conserve processing resources by allowing UEs to demodulate fewer transmission streams concurrently, which may reduce an energy consumption and increase a battery life of UEs. Additionally, the network node dynamically determining the precoder groupings based on channel conditions, UE capabilities, and UE antenna information may conserve network resources by reducing the number of retransmissions due to demodulation errors and improving the overall spectral efficiency of the network.

5G New Radio (NR) may support enhanced mobile broadband (eMBB) access, Internet of Things (IoT) networks or reduced capability (RedCap) device deployments, ultra-reliable low-latency communication (URLLC) applications, or massive machine-type communication (mMTC), among other examples. To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning, radio frequency (RF) sensing, network energy savings (NES), low-power signaling and radios, or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial or aerial platforms, among other examples.

The methods, operations, apparatuses, and techniques described herein may enable one or more of the foregoing technologies or new technologies or support one or more of the foregoing use cases or new use cases.

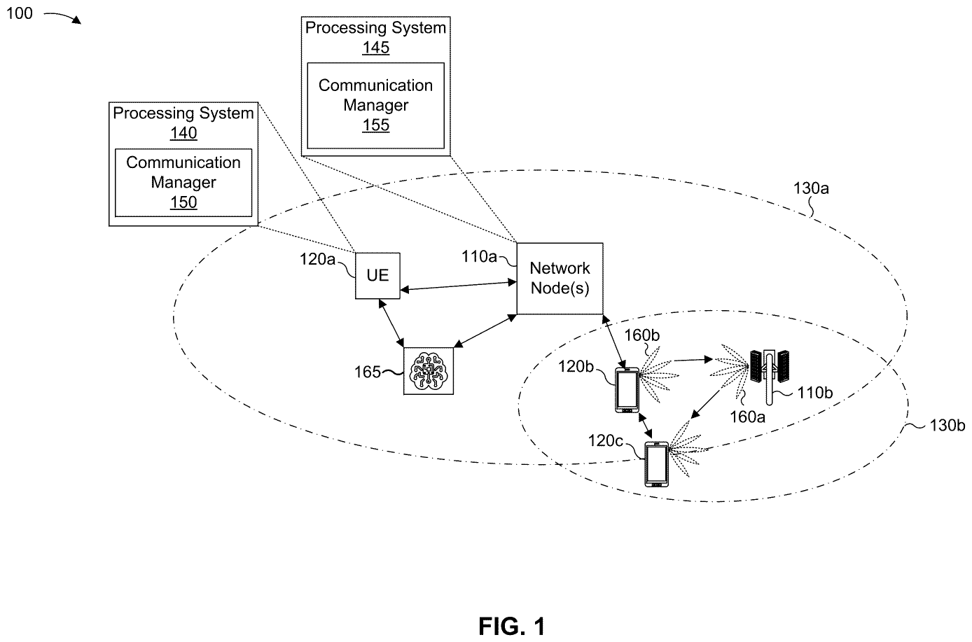

FIG. 1 is a diagram illustrating an example of a wireless communication network 100. The wireless communication network 100 may be or may include elements of a 5G network or a 6G network, among other examples. The wireless communication network 100 may include multiple network nodes 110. For example, in FIG. 1, the wireless communication network 100 includes multiple network nodes 110, including a network node 110a and a network node 110b (each of which also may be referred to herein simply as a “network node 110”). The network nodes 110 may support communications with multiple UEs 120. For example, in FIG. 1, the network nodes 110 support communication with a UE 120a, a UE 120b, and a UE 120c (each of which also may be referred to herein simply as a “UE 120”). In some examples, a UE 120 also may communicate with other UEs 120 and a network node 110 also may communicate with a core network and with other network nodes 110.

The network nodes 110 and the UEs 120 of the wireless communication network 100 communicate using the electromagnetic spectrum, which may be subdivided into various licensed or unlicensed operating bands, frequency ranges, component carriers, or channels that define associated frequencies available for communications. In some examples, each of the network nodes 110 and the UEs 120 may communicate using one or multiple component carriers in one or more operating bands or ranges. Typically, various operating bands are defined as frequency range designations FR1 (410 MHz through 7.125 GHz), FR2 (24.25 GHz through 52.6 GHZ), FR3 (7.125 GHz through 24.25 GHz), FR4a or FR4-1 (52.6 GHz through 71 GHz), FR4 (52.6 GHz through 114.25 GHZ), and FR5 (114.25 GHz through 300 GHz). Although a portion of FR1 is greater than 6 GHZ, FR1 is often referred to (interchangeably) as a “sub-6 GHz” band in some documents and articles. Similarly, FR2 is often referred to (interchangeably) as a “millimeter wave” band in some documents and articles.

A network node 110 or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system. As shown in FIG. 1, each UE 120 includes a processing system 140 and each network node 110 includes a processing system 145. A processing system (for example, the processing system 140 or the processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 and the processing system 145 may each include memory circuitry in the form of one or multiple memory devices, memory blocks, memory elements, or other discrete gate or transistor logic or circuitry, each of which may include or implement tangible storage media, such as random-access memory, or read-only memory, or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors. One or more of the memories may individually or collectively store processor-executable code or instructions (such as software) (for example, which may be referred to as “one or more code-storing memories” or “code-storing memory circuitry”). For example, “code-storing memory” or “code-storing memory circuitry” refers to memory (or memory circuitry) that is configured to store processor-executable code or instructions. The processor-executable code or instructions, when executed by one or more of the processors, may configure one or more of the processors (or processing circuitry) to perform various functions or operations described herein. Additionally, or alternatively, in some examples, one or more of the processors may be configured to perform various functions or operations described herein without requiring configuration by software. Software shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 and the processing system 145 may each include or be coupled with one or more modems (such as a cellular (for example, a 5G or 6G compliant) modem). In some examples, one or more processors of the processing system 140 or the processing system 145 may include or implement one or more of the modems. The processing system 140 and the processing system 145 also may include or be coupled with multiple radios (collectively “the radio”), multiple RF chains, or multiple transceivers, each of which may in turn be coupled with one or more of multiple antennas. In some examples, one or more processors of the processing system 140 or the processing system 145 may include or implement one or more of the radios, RF chains, or transceivers. An RF chain may include one or more filters, mixers, oscillators, amplifiers, analog-to-digital converters (ADCs), or other devices that convert between an analog signal (such as for transmission or reception via an air interface) and a digital signal (such as for processing by the processing system 140 or by the processing system 145).

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device, such as the network node 110 and the UE 120.

A network node 110 may be, may include, or also may be referred to as an NR network node, a 5G network node, a 6G network node, a Node B, a gNB, an access point (AP), a transmission reception point (TRP), a network entity, a network element, a network equipment, or another type of device, component, or system included in a radio access network (RAN). In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may include a single standalone base station or a single TRP that operates with a full radio protocol stack to enable or facilitate communication between a UE 120 and a core network of the wireless communication network 100.

Alternatively, a network node 110 may be a disaggregated network node 110 (sometimes referred to as a disaggregated base station), having a disaggregated architecture, meaning that the network node 110 may operate with a radio protocol stack that is physically distributed or logically distributed among two or more nodes in the same geographic location or in different geographic locations. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The disaggregated network nodes 110 of the wireless communication network 100 may include one or more central units (CUs), one or more distributed units (DUs), and one or more radio units (RUs). A CU may host one or more higher layers, such as a radio resource control (RRC) layer, a packet data convergence protocol (PDCP) layer, and a service data adaptation protocol (SDAP) layer, among other examples. A CU can communicate with a core network either directly (for example, via a backhaul link) or indirectly (for example, via one or more disaggregated control units, such as a non-real-time (Non-RT) RAN intelligent controller (RIC) associated with a Service Management and Orchestration (SMO) framework or a near-real-time (Near-RT) RIC). A DU may host one or more of a radio link control (RLC) layer, a medium access control (MAC) layer, or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. A CU may communicate with one or more DUs via respective midhaul links, such as via F1 interfaces. Each of the DUs may communicate with one or more RUs via respective fronthaul links. Each of the RUs may communicate with one or more UEs 120 via respective RF access links. In some deployments, a UE 120 may be simultaneously served by multiple RUS.

In some examples, a single network node 110 may include a combination of one or more CUs, one or more DUs, or one or more RUs. In some examples, a CU, a DU, or an RU may be implemented as a virtual unit, such as a virtual central unit (VCU), a virtual distributed unit (VDU), or a virtual radio unit (VRU), among other examples, which may be implemented as a virtual network function, such as in a cloud deployment (for example, an open cloud (O-Cloud) platform). An SMO framework may support RAN deployment and provisioning of non-virtualized and virtualized network elements.

In some examples, the wireless communication network 100 may be a heterogeneous network that includes network nodes 110 of various types. Different types of network nodes 110 may generally operate on the same or different operating bands, transmit at different power levels, or serve different coverage areas, each of which may be referred to as or associated with a particular cell 130 (for example, a cell 130a and a cell 130b).

The UEs 120 may be physically dispersed throughout the coverage area of the wireless communication network 100, and each UE 120 may be stationary or mobile. A UE 120 may be, may include, or also may be referred to as an access terminal, a mobile station, a client device, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, or smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), an artificially intelligent robot or other device implementing artificial intelligence, a UE function of a network node, or any other suitable device or function that may communicate in the wireless communication network 100.

Some UEs 120 may be classified according to different categories in association with different complexities or different capabilities. UEs 120 in a first category may be associated with relatively low complexity or cost such as NB-IoT devices or eMTC UEs. UEs 120 in a second category may include higher complexity or cost devices, such as mission-critical IoT devices, baseline UEs, high-tier UEs, advanced UEs, full-capability UEs, or premium UEs that are capable of URLLC, eMBB, or precise positioning in the wireless communication network 100. A third category of UEs 120 may have mid-tier complexity or capabilities (for example, capabilities between that of the UEs 120 of the first category and the UEs 120 of the second category). A UE 120 of the third category may be referred to as a reduced capability UE (“RedCap UE”), a mid-tier UE, an NR-Light UE, or an NR-Lite UE, among other examples.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

Frequency domain resources may be subdivided into bandwidth parts (BWPs). A BWP may be a block of frequency domain resources (for example, a continuous set of resource blocks (RBs) within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a downlink control information (DCI) configuration to the one or more UEs 120) or reconfigured (for example, in real-time or near-real-time) according to changing network conditions in the wireless communication network 100 or specific requirements of one or more UEs 120. An active BWP defines the operating bandwidth of the UE 120 within the operating bandwidth of the serving cell.

As used herein, a downlink signal may be or include a reference signal, control information, or data. For example, downlink reference signals include a primary synchronization signal (PSS), a secondary SS (SSS), an SS block (SSB) (for example, that includes a PSS, an SSS, and a physical broadcast channel (PBCH)), a demodulation reference signal (DMRS), a phase tracking reference signal (PTRS), a tracking reference signal (TRS), and a channel state information (CSI) reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications or downlink data channel communications. A downlink control channel may be specifically used to transmit DCI from a network node 110 to a UE 120. DCI generally contains the information the UE 120 needs to identify RBs in a subsequent subframe and how to decode them, including a modulation and coding scheme (MCS) or redundancy version parameters. Different DCI formats carry different information, such as scheduling information in the form of downlink or uplink grants, slot format indicators (SFIs), preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 120) from a network node 110 to a UE 120. Downlink control channels may include physical downlink control channels (PDCCHs), and downlink data channels may include physical downlink shared channels (PDSCHs). Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more transport blocks (TBs) of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications or uplink data channel communications. An uplink control channel may be specifically used to transmit uplink control information (UCI) from a UE 120 to a network node 110. An uplink data channel may be used to transmit uplink data (for example, user data associated with a UE 120) from a UE 120 to a network node 110. Uplink control channels may include physical uplink control channels (PUCCHs), and uplink data channels may include physical uplink shared channels (PUSCHs). Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ acknowledgement (ACK) indication or a HARQ negative acknowledgement (NACK) indication), uplink power control information (for example, an uplink TPC parameter), or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), or measurement information (for example, a layer 1 (L1)-reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 110 or UE 120 over a wireless communication channel. In some examples, the network node 110 or the UE 120 (for example, using the processing system 145 or the processing system 140, respectively) may select an MCS (for example, an order of quadrature amplitude modulation (QAM), such as 64-QAM, 128-QAM, or 256-QAM, among other examples) for a downlink signal or an uplink signal. For example, the network node 110 may select an MCS for a downlink signal in accordance with UCI received from the UE 120 or may transmit, to the UE 120, an indication of an MCS to be applied for an uplink signal.

A network node 110 or a UE 120 (such as by using the processing system 145 or the processing system 140, respectively, or one or more coupled modems) may perform signal processing on the information (such as filtering, amplification, modulation, digital-to-analog conversion, an IFFT operation, multiplexing, interleaving, mapping, or encoding, among other examples) to generate a processed signal in accordance with the selected MCS. In some examples, the network node 110 or the UE 120 (for example, using the processing system 145 or the processing system 140, respectively, or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 145 or one or more modems) may further perform spatial processing (for example, precoding) on the encoded information to generate one or more processed or precoded signals for downlink or uplink transmission, respectively. In some examples, the network node 110a or the UE 120a may perform codebook-based precoding or non-codebook-based precoding. Codebook-based precoding may involve selecting a precoder (for example, a precoding matrix) using a codebook. For example, the network node 110a may provide precoding information indicating which precoder, defined by the codebook, is to be used by the UE 120a. Non-codebook-based precoding may involve selecting or deriving a precoder based on, or otherwise associated with, one or more downlink or uplink signal measurements. The network node 110a or the UE 120a may transmit the processed downlink or uplink signals, respectively, via one or more antennas.

In some cases, the network node 110a may use a precoder to generate multiple transmission streams within a downlink communication. The network node 110a may be capable of generating the multiple transmission streams based on employing interference cancelation algorithms, including a large number of transmit (Tx) antennas, or using optimal precoders, such as singular value decomposition (SVD). Additionally, the wireless communication network 100 may include a relatively high density of network nodes (such as gNBs), which may yield higher signal-to-noise ratio conditions and enable devices (such as UEs 120) to receive multiple transmission streams simultaneously or concurrently.

The network node 110a or the UE 120a may receive uplink signals or downlink signals, respectively, via one or more antennas. The network node 110a or the UE 120a (for example, using the processing system 145 or the processing system 140, respectively, or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, or decoding, among other examples), to map the received signal(s) to a sequence of binary bits (for example, received information) that estimates the information transmitted by the network node 110 or the UE 120 via the downlink or uplink signals. The network node 110a or the UE 120a (for example, using the processing system 145 or the processing system 140, respectively, or a coupled decoder or one or more modems) may decode the received information (such as by using an ECC, a decoding operation, or an FEC operation) to detect errors or correct bit errors in the received information to generate decoded information. The decoded information may estimate the information transmitted via the downlink or uplink signals.

In some examples, a UE 120 and a network node 110 may perform MIMO communication. MIMO communication generally refers to transmitting or receiving multiple signals (such as multiple layers or multiple data streams or multiple transmission streams) simultaneously over the same time and frequency resources. A network node 110 or a UE 120 may communicate using single-user MIMO or multi-user MIMO (MU-MIMO), the latter of which being used by a network node 110 to simultaneously transmit signals to multiple UEs 120. MIMO techniques may involve spatial multiplexing (multi-layer transmission) or beamforming. To implement beamforming, the amplitudes or phases of signals transmitted via antenna elements may be modulated and shifted relative to each other (such as by manipulating a phase shift, a phase offset, or an amplitude) to generate one or more beams. For example, a network node 110 may generate one or more beams 160a, and a UE 120 may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with such a directional transmission or directional reception, a set of directional resources associated with a signal transmission or signal reception (for example, an angle of arrival, a horizontal direction, or a vertical direction), or a set of parameters or resources associated with one or more aspects of a directional signal, among other examples.

In some examples, a network node 110 or a UE 120 may implement massive MIMO, which may be associated with an increased (for example, “massive”) quantity of antennas at the network node 110 or at the UE 120, such as in a network implementing mmWave technology, which enables more precise beamforming or reduced interference. In some examples, the wireless communication network 100 may implement multi-TRP (mTRP) operation (including redundant transmission or reception on multiple TRPs) or non-coherent joint transmission (NC-JT).

The network node 110 and the UE 120 may establish a communication link or beam pair, and otherwise increase reliability, throughput, signal strength, or other signal properties for MIMO communications, by performing beam management operations, such as an initial beam acquisition operation, a beam refinement operation, or a beam recovery operation. For example, an initial beam acquisition operation may involve the network node 110 transmitting signals (for example, SSBs or other signals) via respective beams (for example, of the beams 160 of the network node 110) and the UE 120 receiving and measuring the signal(s) via respective beams of multiple beams (for example, from the beams 160 of the UE 120) to identify a best beam (or beam pair) for communication between the UE 120 and the network node 110. A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified or defined via one or more spatial parameters, such as a transmission configuration indicator (TCI) state or a quasi-co-location (QCL) parameter, among other examples.

Some aspects and techniques as described herein may be implemented, at least in part, using an artificial intelligence (AI) program (for example, referred to herein as an “AI/ML model”), such as a program that includes a machine learning (ML) model or an artificial neural network (ANN) model. The AI/ML model may be deployed at one or more devices 165 (for example, one or more network nodes 110, one or more UEs 120, one or more servers, or one or more components of a cloud computing network, among other examples). For example, in a deployment in which AI/ML functionality is performed independently at a device 165, sometimes referred to as “overlay AI/ML,” the AI/ML model (or an instance or portion of the AI/ML model) may be deployed at a UE 120 (for example, by the processing system 140), a network node 110 (for example, by the processing system 145), one or more servers, or one or more components of a cloud computing network, among other examples. Additionally, or alternatively, in a deployment where AI/ML functionality is coordinated between different devices 165, sometimes referred to as “coordinated AI/ML,” or performed at all device and network layers, sometimes referred to as “native AI/ML,” the AI/ML model (or an instance of the AI/ML model) may be deployed at multiple devices 165 (for example, a first portion of the AI/ML model may be deployed at a UE 120 and a second portion of the AI/ML model may be deployed at a network node 110). In other examples of coordinated AI/ML or native AI/ML, a first AI/ML model may be deployed at a UE 120 and a second AI/ML model may be deployed at a network node 110. The AI/ML model(s) may be configured to enhance various aspects of the wireless communication network 100 (for example, to increase privacy, reliability, or efficient use of network bandwidth, or to reduce latency, among other examples). For example, the AI/ML model(s) may be trained to identify patterns or relationships in data corresponding to the wireless communication network 100, a device, or an air interface, among other examples. The AI/ML model(s) may support operational decisions relating to one or more aspects associated with wireless communications devices, networks, or services.

Accordingly, in some examples, the AI/ML model(s) may enable AI-as-a-Service (for example, an end-to-end AI/ML service via a user plane) for use cases, such as a self-organizing network (SON), minimization of drive test (MDT), quality of experience (QoE), positioning, sensing, predictive mobility, or traffic prediction, among other examples. In some examples, AI-as-a-Service use cases may include measurement collection reporting by a UE 120, device selection criteria (for example, according to a geographical area where measurements are to be collected or UE capabilities to be used to collected measurements), or reporting configurations (for example, reporting parameters such as location, time, or sensor information, among other examples). Additionally, or alternatively, the AI/ML model(s) may enable AI/ML procedures (for example, RAN-triggered service establishment, configuration, inferencing using UE-side or network-side models, performance monitoring or management, or capability signaling, among other examples). Additionally, or alternatively, the AI/ML model(s) may enable RAN-based AI/ML services via one or more application program interfaces (APIs) or management interfaces for use cases, such as beam management, radio resource monitoring (RRM) relaxation, mobility prediction, load prediction, network energy savings, or coverage and capacity improvements, among other examples).

In the wireless communication network 100, a network node 110 may be capable of transmitting multiple transmissions streams in a downlink communication. For example, a network node 110a may be capable of transmitting a downlink communication that includes four or eight transmission streams in a downlink communication. Some UEs 120 may also be equipped with multiple Rx antennas, which may enable the UEs 120 to receive the multiple transmission streams of the downlink communication. But despite including the multiple Rx antennas, some UEs 120 may not have a capability of demodulating the same quantity of transmission streams concurrently.

Various aspects relate generally to enabling a UE 120 that has limited demodulation capabilities to receive downlink communications with multiple transmission streams. For example, a network node 110 may precode a downlink communication that includes multiple transmission streams using a split precoder, which splits the multiple transmission streams into two subsets that a receiving wireless communication device (e.g., a UE 120) may demodulate independently. Accordingly, a UE 120 that is capable of receiving a first quantity of transmission streams but is only capable of demodulating a second quantity, that is fewer than the first quantity, of transmission streams concurrently may receive the downlink communication and perform two demodulation operations (e.g., on the two subsets of transmission streams) to demodulate the downlink communication. For example, a UE 120 that is equipped with eight Rx antennas and is capable of demodulating up to four transmission streams concurrently may receive a communication from the network node that includes eight transmission streams, demodulate a first subset of the transmission streams (e.g., that includes four transmission streams received by four of the Rx antennas), and separately demodulate a second subset of the transmission streams (e.g., that includes the other four transmission streams received by the other four Rx antennas of the UE 120).

In some aspects, the UE 120 may include a communication manager 150. As described in more detail elsewhere herein, the communication manager 150 may receive, from a network node, configuration information indicating a first grouping of a first subset of a plurality of transmission streams with a first subset of a plurality of antennas at the UE and a second grouping of a second subset of the plurality of transmission streams with a second subset of the plurality of antennas; receive, from the network node using the plurality of antennas, a communication via the plurality of transmission streams; demodulate the first subset of the plurality of transmission streams received by the first subset of the antennas based at least in part on the configuration information; and demodulate the second subset of the plurality of transmission streams received by the second subset of the antennas based at least in part on the configuration information. Additionally, or alternatively, the communication manager 150 may perform one or more other operations described herein.

In some aspects, the network node 110 may include a communication manager 155. As described in more detail elsewhere herein, the communication manager 155 may transmit, to a UE, configuration information indicating a first grouping of a first subset of a plurality of transmission streams with a first subset of a plurality of antennas at the UE and a second grouping of a second subset of the plurality of transmission streams with a second subset of the plurality of antennas; apply a precoder to a signal to generate a communication in accordance with the configuration information; and transmit, to the UE using the plurality of antennas, the communication via the plurality of transmission streams. Additionally, or alternatively, the communication manager 155 may perform one or more other operations described

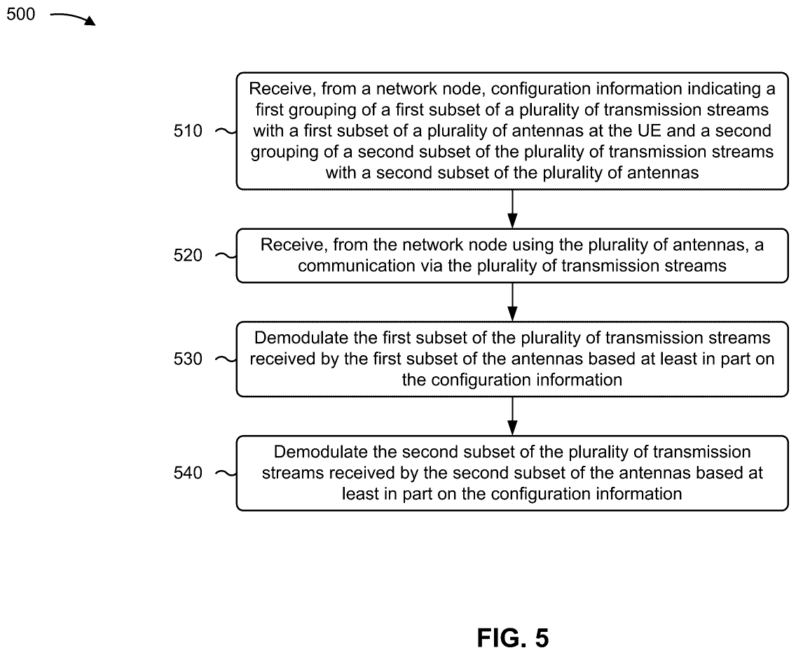

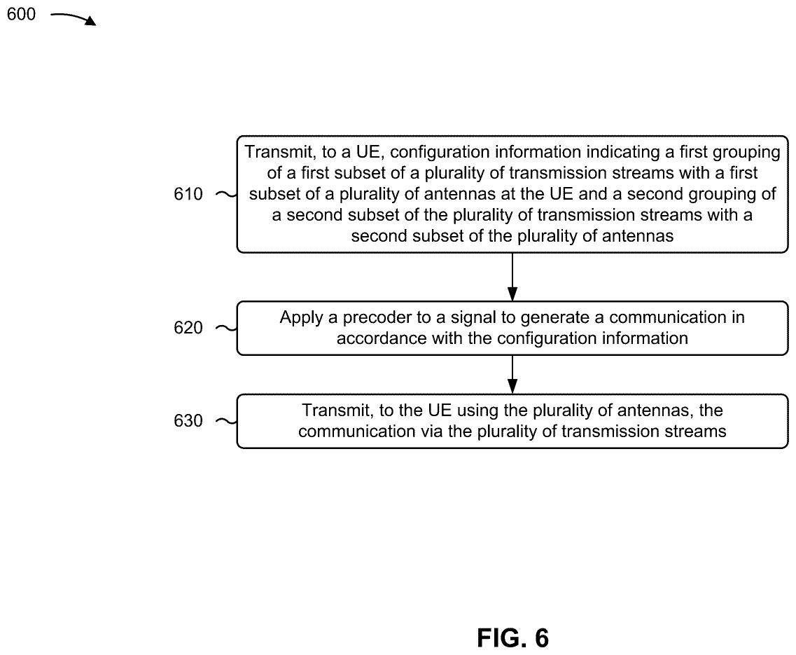

The network node 110, the processing system 145 of the network node 110, the UE 120, the processing system 140 of the UE 120, or any other component(s) of FIG. 1 may implement one or more techniques or perform one or more operations associated with dynamic precoder groupings, as described in more detail elsewhere herein. For example, the processing system 145 of the network node 110, or the processing system 140 of the UE 120 may perform or direct operations of, for example, process 500 of FIG. 5, process 600 of FIG. 6, or other processes as described herein (alone or in conjunction with one or more other processors). Memory of the network node 110 may store data and program code (or instructions) for the network node 110. In some examples, the memory of the network node 110 may store data relating to a UE 120, such as RRC state information or a UE context. Memory of a UE 120 may store data and program code (or instructions) for the UE 120, such as context information. In some examples, the memory of the UE 120 or the memory of the network node 110 may include a non-transitory computer-readable medium storing a set of instructions for wireless communication. For example, the set of instructions, when executed by one or more processors (for example, of the processing system 145 or the processing system 140) of the network node 110, or the UE 120, may cause the one or more processors to perform process 500 of FIG. 5, process 600 of FIG. 6, or other processes as described herein. In some examples, executing instructions may include running the instructions, converting the instructions, compiling the instructions, or interpreting the instructions, among other examples.

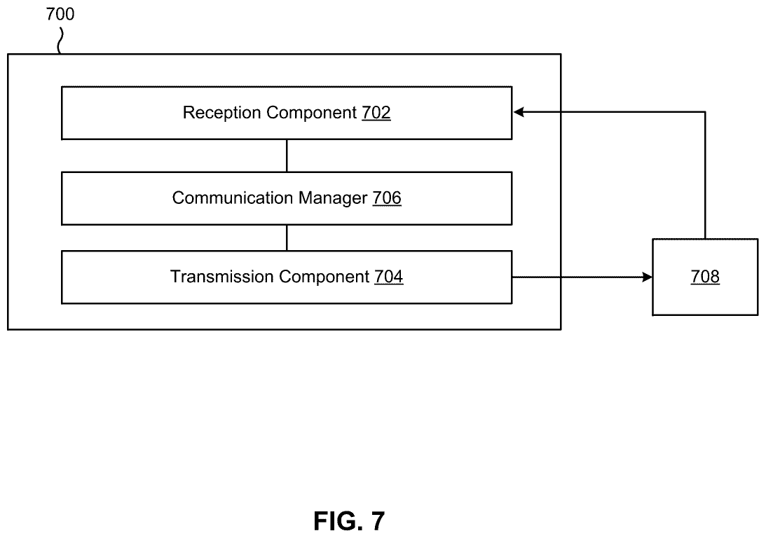

In some aspects, the UE 120 includes means for receiving, from a network node, configuration information indicating a first grouping of a first subset of a plurality of transmission streams with a first subset of a plurality of antennas at the UE and a second grouping of a second subset of the plurality of transmission streams with a second subset of the plurality of antennas; means for receiving, from the network node using the plurality of antennas, a communication via the plurality of transmission streams; means for demodulating the first subset of the plurality of transmission streams received by the first subset of the antennas based at least in part on the configuration information; or means for demodulating the second subset of the plurality of transmission streams received by the second subset of the antennas based at least in part on the configuration information. The means for the UE 120 to perform operations described herein may include, for example, one or more of communication manager 150, processing system 140, a radio, one or more RF chains, one or more transceivers, one or more antennas, one or more modems, a reception component (for example, reception component 702 depicted and described in connection with FIG. 7), or a transmission component (for example, transmission component 704 depicted and described in connection with FIG. 7), among other examples.

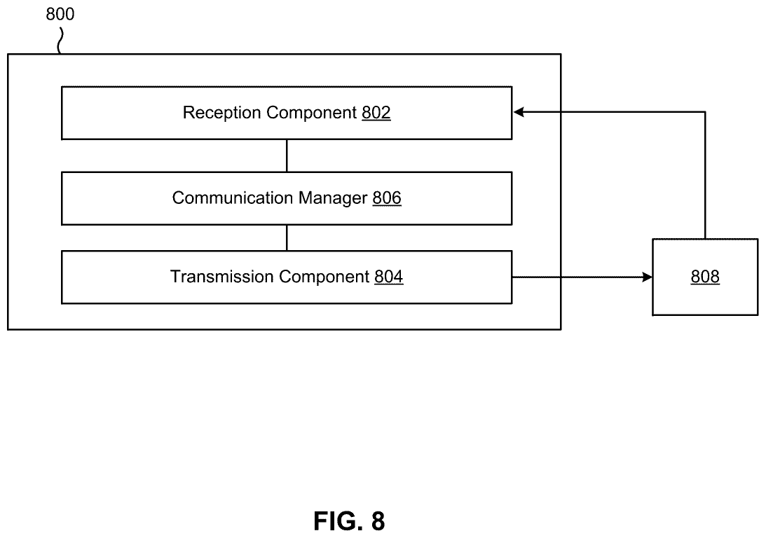

In some aspects, the network node 110 includes means for transmitting, to a UE, configuration information indicating a first grouping of a first subset of a plurality of transmission streams with a first subset of a plurality of antennas at the UE and a second grouping of a second subset of the plurality of transmission streams with a second subset of the plurality of antennas; means for applying a precoder to a signal to generate a communication in accordance with the configuration information; or means for transmitting, to the UE using the plurality of antennas, the communication via the plurality of transmission streams. The means for the network node 110 to perform operations described herein may include, for example, one or more of communication manager 155, processing system 145, a radio, one or more RF chains, one or more transceivers, one or more antennas, one or more modems, a reception component (for example, reception component 802 depicted and described in connection with FIG. 8), or a transmission component (for example, transmission component 804 depicted and described in connection with FIG. 8), among other examples.

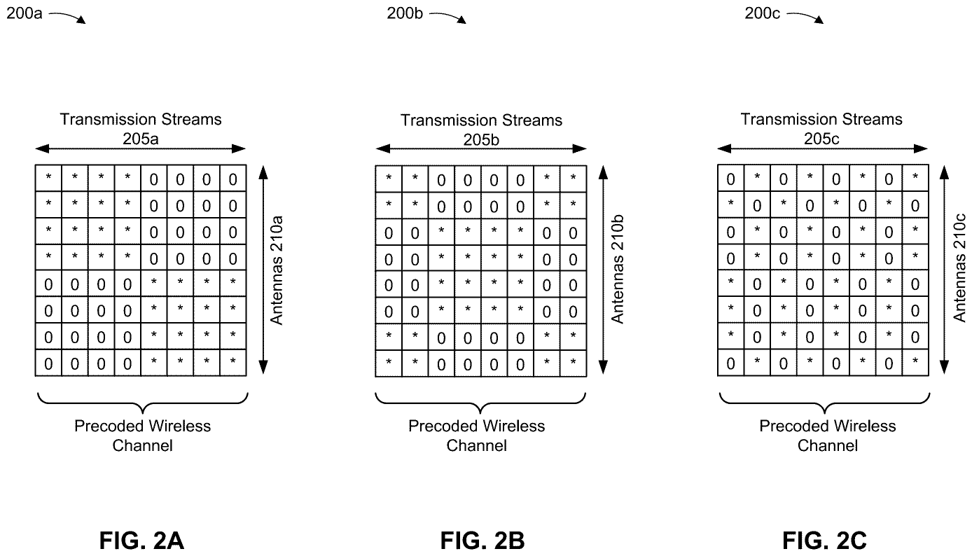

FIGS. 2A, 2B, and 2C are diagrams illustrating examples 200a, 200b, and 200c, respectively, of precoded channels that are associated with dynamic precoder groupings. In particular, the precoded channels may be configured to transmit communications that are mapped to eight transmission streams 205 and eight antennas 210. The eight transmission streams 205 may correspond to eight Tx antennas at a transmitting device (e.g., a network node 110), and the eight antennas 210 may correspond to eight Rx antennas at a receiving device (e.g., a UE 120).

In the examples 200, the * corresponds to data that is transmitted via the precoded channel, and 0 corresponds to zeroed entries that a receiving device does not have to demodulate in order to decode the communication carried by the precoded channel. While the examples 200 illustrate precoded channels associated with eight transmission streams 205 (e.g., corresponding to eight transmission antennas) and eight Rx antennas 210, these techniques may be applied to precoded channels of other sizes.

In some cases, the precoder used by the network node 110 to split a downlink communication into two independent subsets of transmission streams 205 may correspond to an optimal splitter precoder (OSP). An OSP is a precoder that is configured to divide a precoded X-transmission-stream wireless channel (e.g., an eight-transmission-stream wireless channel) over which a downlink communication is transmitted into two sub-channels (e.g., into two 4×4 sub-channels that each correspond to a subset of four transmission streams 205), ensuring that the X transmission streams 205 of the downlink communication are observed at a receiver device, such as a UE 120, as two decoupled groups of transmission streams 205 (e.g., a first subset of four transmission streams 205 and a second subset of four transmission streams 205). Using the OSP to divide the precoded channel over which the downlink communication is transmitted may enable the receiver device to perform two different lower-order demodulations for each of the two groups of four transmission streams 205. Accordingly, the receiver device may be able to receive downlink communications that include eight transmission streams 205. In some cases, the OSP may assume a “closed loop” system, where a network node 110 may have CSI of a downlink channel over which the downlink communication is to be transmitted (e.g., due to channel reciprocity).

FIG. 2A illustrates an example 200a of a precoded wireless channel Hp where a network node 110 uses an OSP to block-diagonalize the channel. More specifically, an OSP, p, may change the wireless channel H such that the precoded wireless channel, Hp, is block-diagonalized as shown in Equation 1, below.

$$Hp = [ \begin{matrix}A & 0 \\ 0 & B\end{matrix} ] , \qquad ( 1 )$$

In Equation 1, A and B each represent 4×4 sub-channels on which data of a communication will be transmitted and the zeros (0, 0) each represent a 4×4 matrix of zeros. While Equation 1 illustrates one matrix in which the precoded wireless channel is block diagonal, Equation 1 may also be rewritten to be block diagonal as shown in Equation 2.

$$Hp = [ \begin{matrix}0 & A \\ B & 0\end{matrix} ] , \qquad ( 2 )$$

To generate the OSP, a transmitter device, such as a network node, may define and use a number of parameters, as shown in Equation 3, including H₁, H₂, p₁, p₂, according to:

$$Hp = [ \begin{matrix}{H}_{1} \\ {H}_{2}\end{matrix} ] [ {p}_{1} {p}_{2} ] , \qquad ( 3 )$$

where H₁, H₂ are 4×8 matrixes that represent “upper” and “lower” parts of the wireless channel, respectively, and p₁, p₂ are 8×4 matrixes that represent a left and a right part of the OSP, respectively.

From matrix multiplication theory and Equations 1 and 3, the precoded block-diagonalized wireless channel illustrated by example 200a may be represented as shown in Equation 4:

$$Hp = [ \begin{matrix}{H}_{1} {p}_{1} = A & {H}_{1} {p}_{2} = 0 \\ {H}_{2} {p}_{1} = 0 & {H}_{2} {p}_{2} = B\end{matrix} ] \qquad ( 4 )$$

In order to force H₂p₁ to be equal to a zero matrix, p₁ should be part of the “null space” of H₂, leading to Equation 5, below. Similarly, in order to force H₁p₂ to be equal to a zero matrix, p₂ should be part of the “null space” of H₁, leading to Equation 6, below.

$${H}_{1} {p}_{2} = 0 \to {p}_{2} = {\underbrace{( {{H}_{1}^{H} ( {H}_{1} {H}_{1}^{H} )}^{- 1} {H}_{1} - 1 )}}_{{M}_{1}} {\tilde{p}}_{2} = {M}_{1} {\tilde{p}}_{2} ∀ {\tilde{p}}_{2} \qquad ( 5 )$$

$${H}_{2} {p}_{1} = 0 \to {p}_{1} = {\underbrace{( {{H}_{2}^{H} ( {H}_{2} {H}_{2}^{H} )}^{- 1} {H}_{2} - 1 )}}_{{M}_{2}} {\tilde{p}}_{1} = {M}_{2} {\tilde{p}}_{1} ∀ {\tilde{p}}_{1} \qquad ( 6 )$$

In Equations 5 and 6, \tilde{p}₁ and \tilde{p}₂ may be any 8×4 fully ranked matrices, and I may correspond to the identify matrix. How to determine the precoder matrices \tilde{p}₁ and \tilde{p}₂, and how to select a demodulator at the receiver device using a linear minimum mean square error (LMMSE) optimization problem, are explained below.

To demodulate the precoded downlink transmission, the demodulator, G, may be split into two different 4×4 demodulators according to Equation 7:

$$G = [ \begin{matrix}{G}_{1} & 0 \\ 0 & {G}_{2}\end{matrix} ] \qquad ( 7 )$$

The received precoded downlink communication after equalization may be represented as y_{eq}=GHpx+Gn, where x is an 8×1 vector that represents the transmission streams 205a over which data in the downlink communication is transmitted and n is an 8×1 vector which represents additive noise at the receiver device.

The LMMSE optimization problem for selecting the precoder matrices \tilde{p}₁ and \tilde{p}₂ the demodulator G₁ and G₂ may then be applied according to Equation 8:

$$arg {min}_{{\tilde{p}}_{1} , {\tilde{p}}_{2}} {‖ [ \begin{matrix}{G}_{1} & 0 \\ 0 & {G}_{2}\end{matrix} ] \{ [ \begin{matrix}{H}_{1} {M}_{2} {\tilde{p}}_{1} & 0 \\ 0 & {H}_{2} {M}_{1} {\tilde{p}}_{2}\end{matrix} ] [ \begin{matrix}{x}_{u} \\ {x}_{l}\end{matrix} ] + [ \begin{matrix}{n}_{u} \\ {n}_{l}\end{matrix} ] \} - [ \begin{matrix}{x}_{u} \\ {x}_{l}\end{matrix} ] ‖}_{2}^{2} \qquad ( 8 )$$

In Equation 8, xᵤ is a first 4×1 vector representing a first (or upper) group of streams of the 8×1 vector x representing the transmission streams 205a over which the downlink communication is received at the receiver device, and xₗ is a second 4×1 vector representing a second (or lower) group of transmission streams 205a of the 8×1 vector x representing the transmission streams 205a over which the downlink communication is received at the receiver device. Similarly, nu represents a first 4×1 vector of the 8×1 vector n of additive noise corresponding to the first (or upper) group of streams, and nₗ represents a second 4×1 vector of the 8×1 vector n of additive noise corresponding to the second (or lower) group of transmission streams 205a.

Due to the full separation of the two groups of transmission streams 205a, the LMMSE optimization problem may be separated into two optimization problems as shown in Equations 9 and 10, below. For example, Equation 9 may be used to determine a best precoder \tilde{p}₁ and a best demodulator G₁ for a given channel \tilde{H}₁.

$$arg {min}_{{\tilde{p}}_{1}} {‖ {G}_{1} \{ {\underbrace{{H}_{1} {M}_{2}}}_{{\tilde{H}}_{1}} {\tilde{p}}_{1} {x}_{u} + {n}_{u} \} - {x}_{u} ‖}_{2}^{2} = arg {min}_{{\tilde{p}}_{1}} {‖ {G}_{1} \{ {\tilde{H}}_{1} {\tilde{p}}_{1} {x}_{u} + {n}_{u} \} - {x}_{u} ‖}_{2}^{2} \qquad ( 9 )$$

Similarly, Equation 10 may be used to determine a best precoder \tilde{p}₂ and a best demodulator G₂ for a given channel \tilde{H}₂.

$$arg {min}_{{\tilde{p}}_{2}} {‖ {G}_{2} \{ {\underbrace{{H}_{2} {M}_{1}}}_{{\tilde{H}}_{2}} {\tilde{p}}_{2} {x}_{l} + {n}_{l} \} - {x}_{l} ‖}_{2}^{2} = arg {min}_{{\tilde{p}}_{2}} {‖ {G}_{2} \{ {\tilde{H}}_{2} {\tilde{p}}_{2} {x}_{l} + {n}_{l} \} - {x}_{l} ‖}_{2}^{2} \qquad ( 10 )$$

To solve the optimization problems shown in Equation 9 and Equation 10, the transmitter device may perform two singular value decompositions (SVDs) according to Equations 11 and 12, respectively, below.

$$[ {u}_{1} {\sum }_{1} {v}_{1} ] = svd ( \text{?} ) = svd ( {H}_{1} {M}_{2} ) \qquad ( 11 )$$

$$[ {u}_{2} {\sum }_{2} {v}_{2} ] = svd ( \text{?} ) = s v d ( {H}_{2} {M}_{1} ) \qquad ( 12 )$$

The transmitter device may then determine \tilde{p}₁ according to

$${\tilde{p}}_{1} = \frac{{V}_{1}}{\sqrt{{N}_{ss}}} ,$$

and \tilde{p}₂ according to

$${\tilde{p}}_{2} = \frac{{V}_{2}}{\sqrt{{N}_{ss}}} ,$$

where Nₛₛ is the number of transmission streams 205a to be used for a downlink communication to the receiver device. Additionally, the transmitter device may determine G₁ according to

$${G}_{1} = {U}_{1}^{H} {\sum }_{1}^{- 1}$$

and G₂ according to

$${G}_{2} = {U}_{2}^{H} {\sum }_{2}^{- 1} .$$

Finally, to determine the precoder, p, the transmitter device may calculate M₁ and M₂ based on a reciprocity assumption and use M₁ and M₂ to determine p₁ and p₂ of the precoder p according to p₁=M₂\tilde{p}₁ and p₂=M₁\tilde{p}₂.

The transmitter device may then apply the OSP, p, to a downlink signal for transmission to the receiver device on the wireless channel (e.g., H), which will block-diagonalize the wireless channel into a plurality of sub-channels (e.g., H₁ and H₂), each sub-channel comprising a different or separate group of transmission streams 205a that are separately demodulatable by the receiver device. Thereafter, the transmitter device may transmit the precoded downlink signal to the receiver device on the wireless channel using the different groups of transmission streams 205a. Additionally, the techniques described above may be used by the transmitter device or receiver device to determine a demodulator (e.g., G, including G₁ and G₂) that the receiver device may use to separately demodulate the different groups of transmission streams 205a used to transmit the downlink transmission.

In the example 200a, the OSP groups a first subset of the transmission streams 205a {1, 2, 3, 4} with a first subset of the antennas 210a {1, 2, 3, 4}. Additionally, the OSP groups a second subset of the transmission streams 205a {5, 6, 7, 8} with a second subset of the antennas 210a {5, 6, 7, 8}. Accordingly, a receiving device may demodulate the first subset of the transmission streams 205a {1, 2, 3, 4} with the first subset of the antennas 210a {1, 2, 3, 4}. Additionally, the receiving device may demodulate the second subset of the transmission streams 205a {5, 6, 7, 8} with the second subset of the antennas 210a {5, 6, 7, 8}.

FIG. 2B illustrates an example 200b where the OSP groups different subsets of the transmission streams 205b with different subsets of the antennas 210b. That is, in the example 200b, the OSP may group a first subset of the transmission streams 205b {1, 2, 7, 8} with a first subset of the antennas 210b {1, 2, 7, 8}. Additionally, the OSP groups a second subset of the transmission streams 205b {3, 4, 5, 6} with a second subset of the antennas 210b {3, 4, 5, 6}. Accordingly, a receiving device may demodulate the first subset of the transmission streams 205b {1, 2, 7, 8} with the first subset of the antennas 210b {1, 2, 7, 8}. Additionally, the receiving device may demodulate the second subset of the transmission streams 205b {3, 4, 5, 6} with the second subset of the antennas 210b {3, 4, 5, 6}.

FIG. 2C illustrates another example 200c where the OSP groups different subsets of the transmission streams 205c with different subsets of the antennas 210c. That is, in the example 200c, the OSP may group a first subset of the transmission streams 205c {1, 3, 5, 7} with a first subset of the antennas 210c {2, 5, 6, 7}. Additionally, the OSP groups a second subset of the transmission streams 205c {2, 4, 6, 8} with a second subset of the antennas 210c {1, 3, 4, 8}. Accordingly, a receiving device may demodulate the first subset of the transmission streams 205c {1, 3, 5, 7} with the first subset of the antennas 210c {2, 5, 6, 7}. Additionally, the receiving device may demodulate the second subset of the transmission streams 205c {2, 4, 6, 8} with the second subset of the antennas 210c {1, 3, 4, 8}.

In some cases, to determine the OSP p associated with the precoded channels that are not exclusively block-diagonalized,

$$( e . g . , such that Hp = [ \begin{matrix}A & 0 \\ 0 & B\end{matrix} ] ) ,$$

a transmitting device may swap one or more rows or columns prior to calculating the OSP p, as described with reference to FIG. 2A. That is, the transmitting device may swap the rows of the wireless channel H to generate H̅. For example, to determine the OSP p associated with the example 200b illustrated by FIG. 2B, if the wireless channel

$$H = {[ \begin{matrix}\vert \vert \vert \vert \vert \vert \vert \vert \\ {h}_{1} {h}_{2} {h}_{3} {h}_{4} {h}_{5} {h}_{6} {h}_{7} {h}_{8} \\ \vert \vert \vert \vert \vert \vert \vert \vert\end{matrix} ]}^{T} ,$$

where the i^{th} row of the wireless channel H is hᵢ, the transmitting device may swap rows {7, 8} with rows {3, 4} to generate H̅, such that

$$\overline{H} = {[ \begin{matrix}\vert \vert \vert \vert \vert \vert \vert \vert \\ {h}_{1} {h}_{2} {h}_{7} {h}_{8} {h}_{5} {h}_{6} {h}_{3} {h}_{4} \\ \vert \vert \vert \vert \vert \vert \vert \vert\end{matrix} ]}^{T} .$$

In another example, to determine the OSP p associated with the example 200c illustrated by FIG. 2C, the transmitting device may swap rows {2, 3, 4, 5, 6, 7} with rows {3, 5, 7, 2, 4, 6} to generate H̅, such that

$$\overline{H} = {[ \begin{matrix}\vert \vert \vert \vert \vert \vert \vert \vert \\ {h}_{1} {h}_{3} {h}_{5} {h}_{7} {h}_{2} {h}_{4} {h}_{6} {h}_{8} \\ \vert \vert \vert \vert \vert \vert \vert \vert\end{matrix} ]}^{T} .$$

As a result of swapping the one or more rows to generate H̅, the order of the transmission streams 205 may be different. In the example 200b, the order of the transmission streams 205b in H̅ may be {1, 2, 7, 8, 5, 6, 3, 4}. In the example 200c, the order of the transmission streams 205c in H̅ may be {1, 3, 5, 7, 2, 4, 6, 8}.

The transmitting device may then determine p̅₁, p̅₂ as described with reference to Equations 3 through 12, but using H instead of H. Then the transmitting device may reorder the antennas 210. In the example 200b illustrated by FIG. 2B, the ordering of the antennas 210b may be based on swapping columns {7, 8} with columns {3, 4}. Accordingly, the order of the antennas 210b may be reordered to {1, 2, 7, 8, 5, 6, 3, 4}. In the example 200c illustrated by FIG. 2C, the ordering of the antennas 210c may be based on swapping columns {1, 2, 3, 4, 5, 6, 7} with columns {2, 5, 6, 7, 1, 3, 4}. Accordingly, the order of the antennas 210c may be reordered to {2, 5, 6, 7, 1, 3, 4, 8}. After reordering the antennas 210, the transmitting device may build p from p̅₁, p̅₂ according to the ordering of the antennas 210 (e.g., instead of simply concatenating them as described with reference to FIG. 2A).

The receiving device may similarly swap the rows of the wireless channel H to determine a demodulator (e.g., G, including G₁ and G₂) that the receiver device may use to separately demodulate the different groups of transmission streams 205 used to transmit the downlink transmission.

As indicated above, FIGS. 2A, 2B, and 2C are provided as examples. Other examples may differ from what is described with respect to FIGS. 2A, 2B, and 2C.

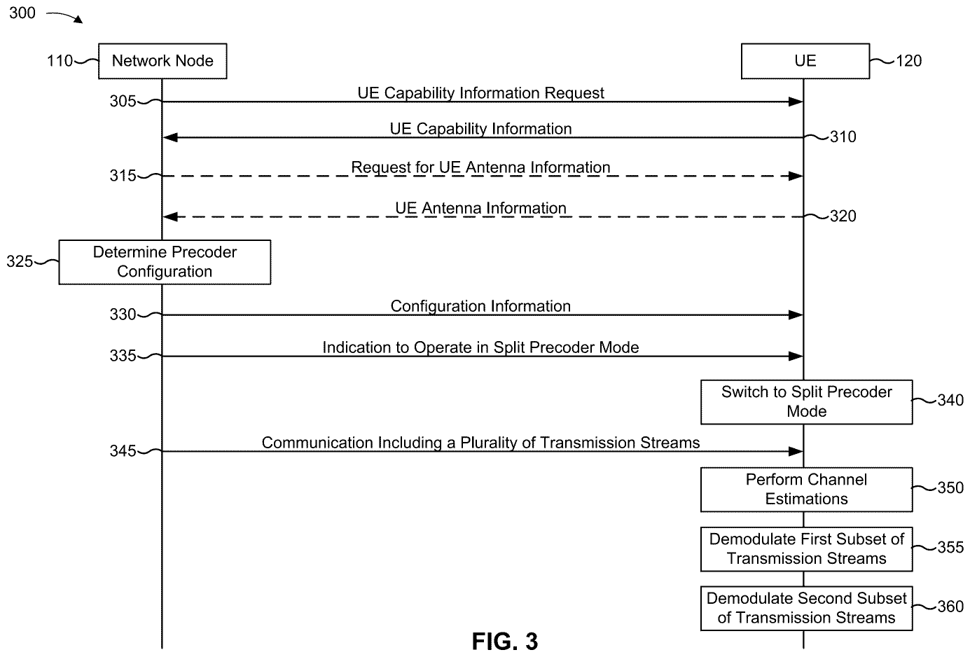

FIG. 3 is a diagram illustrating an example 300 associated with dynamic precoder groupings. As shown in FIG. 3, a network node 110 and a UE 120 may communicate with one another. The example 300 may be associated with the network node 110 dynamically configuring precoder groupings (e.g., groupings of subsets of transmission streams with subsets of antennas at the UE 120) that enable a UE to receive downlink communications that include more transmission streams than the UE 120 is capable of or configured to demodulate concurrently.

As shown by reference number 305, the network node 110 may transmit, and the UE 120 may receive, a request for UE capability information. The network node 110 may transmit the request for the UE capability information via a MAC-CE.

As shown by reference number 310, the UE 120 may transmit, and the network node 110 may receive, the UE capability information. In some cases, the UE 120 may transmit the UE capability information to the network node 110 in response to receiving the UE capability information request. The UE capability information may indicate, to the network node 110, a demodulation capability of the UE 120. The demodulation capability of the UE 120 may indicate, for example, a quantity of transmission streams that the UE 120 is capable of demodulating concurrently. In some cases, the quantity of transmission streams that the UE 120 is capable of demodulating concurrently may correspond to a maximum quantity of transmission streams that the UE 120 is capable of simultaneously demodulating (e.g., within a single demodulation operation). The quantity of transmission streams that the UE 120 is capable of demodulating concurrently (or that the UE 120 is capable of demodulating within a single demodulation operation) may be based on a hardware configuration of the UE 120. That is, the hardware configuration of the UE 120 may not support the complexity or power consumption associated with demodulating more than the quantity of transmission streams concurrently (or within a single demodulation operation).

In some other cases, the UE capability information may indicate a quantity of transmission streams that the UE 120 is configured to demodulate concurrently (or within a single demodulation operation). For example, the UE 120 may be operating in a low power mode (e.g., a low battery mode) that is associated with demodulating fewer transmission streams concurrently. That is, the UE 120 may be capable of demodulating eight transmission streams concurrently, but may be operating in a low power mode. Based on operating in the low power mode, the UE 120 may demodulate no more than four transmission streams concurrently. Here, the UE 120 may indicate, via the UE capability information, the quantity of transmission streams that the UE 120 is configured to demodulate concurrently (e.g., four). The UE 120 may transmit the UE capability information via a MAC-CE.

As shown by reference number 315, the network node 110 may optionally transmit, and the UE 120 may receive, a request for information associated with a set of antennas at the UE 120 (e.g., a request for UE antenna information). The set of antennas at the UE 120 may correspond to a set of Rx antennas at the UE 120. In some cases, the request for information may additionally indicate a type of information. For example, the network node 110 may determine a precoder configuration for communications between the network node 110 and the UE 120 based on one or more parameters associated with the set of antennas at the UE 120 or based on one or more other metrics. Accordingly, the network node 110 may request for the UE 120 to transmit, to the network node 110, signaling indicating any information, parameters, or metrics relied upon by the network node 110 to determine the precoder configuration. For example, the network node 110 may request for the UE 120 to transmit signaling indicating one or more antenna correlation values associated with the set of antennas at the UE 120. In another example, the network node 110 may request for the UE 120 transmit signaling indicating an autocovariance matrix associated with the set of antennas at the UE 120.

As shown by reference number 320, the UE 120 may optionally transmit, and the network node 110 may optionally receive, signaling indicating information associated with the set of antennas at the UE 120 (e.g., signaling indicating the UE antenna information). The UE antenna information may include an autocovariance matrix associated with the set of antennas. Additionally, or alternatively, the UE antenna information may include a set of antenna correlation values associated with the set of antennas at the UE 120.

The correlation between different antennas at the UE 120 may be based on one or more different factors. For example, the physical distance between antennas at the UE 120 may affect the antenna correlation of the antennas. That is, antennas that are closer to each other may tend to have higher correlation due to experiencing similar signal paths and multipath effects. Additionally, the orientation of the antennas at the UE 120 may influence the antenna correlation of the antennas. That is, antennas pointing in different directions may receive signals with different characteristics, which may result in lower correlation between antennas that are oriented in different directions. Further, the surrounding propagation environment, including obstacles and reflectors, may impact the antenna correlation of the antennas at the UE 120. That is, the surrounding propagation environment may affect how signals scatter and reach the antennas. Accordingly, rich scattering environments with many reflections may reduce the antenna correlation of the antennas at the UE 120 by providing diverse signal paths. Furthermore, the frequency of the signal may impact the antenna correlation of the antennas at the UE 120. That is, antennas may be spaced closer together to receive signals with higher frequencies in order to maintain the same level of correlation as if the antennas were configured to receive signals with lower frequencies. The polarizations of the antennas at the UE 120, such as vertical versus horizontal polarization, may also affect the antenna correlation of the antennas by causing the antennas to receive signals differently. Additionally, the specific design and characteristics of the antennas at the UE 120, including the radiation patterns and gain, may influence the antenna correlation of the antennas by affecting how the antennas interact with incoming signals.

In some cases, the UE 120 may transmit the UE antenna information to the network node 110 in response to receiving the request for the UE antenna information. If the request for the UE antenna information includes a request for a specific type of antenna information or any other parameters or metrics, the UE 120 may include the requested information, parameters, or metrics, within the UE antenna information.

As shown by reference number 325, the network node 110 may determine a precoder configuration. In some cases, the network node 110 may determine the precoder configuration based on the UE capability information. That is, when the UE capability information indicates that the quantity of transmission streams that the UE 120 is capable of or configured to demodulate concurrently is greater than or equal to a quantity of transmission streams to be used for communication to the UE 120, the network node 110 may determine that a precoder configuration is associated with an SVD precoder (e.g., where the channel is not divided into groups of transmission streams).

Alternatively, when the UE capability information indicates that the quantity of transmission streams that the UE 120 is capable of demodulating concurrently is less than a quantity of transmission streams to be used for a communication to the UE 120, the network node 110 may determine a precoder configuration associated with an OSP in order to divide the wireless channel over which the communication is to be transmitted into a plurality of separate sub-channels on which the UE 120 is able to perform two separate lower-order demodulations.

In the example 300, the network node 110 may determine that the precoder configuration is associated with the OSP. That is, the UE capability information may indicate that the quantity of transmission streams that the UE 120 is capable of demodulating concurrently is less than a quantity of transmission streams to be used for a communication to the UE 120. When the precoder configuration is associated with the OSP, the precoder configuration may be indicative of a first grouping of a first subset of transmission streams with a first subset of antennas at the UE 120 and a second grouping of a second subset of transmission streams with a second subset of antennas at the UE 120. That is, the network node 110 may determine a precoder configuration associated with a precoder p that divides a channel into two groups of transmission streams that are separately demodulatable by the UE 120, as described with reference to FIG. 2.

The network node 110 may determine the specific precoder p configuration based on a capacity of the channel. That is, the network node 110 may select a precoder p that increases a capacity of the channel between the network node 110 and the UE 120 (e.g., as compared to one or more other precoders p). To select the precoder p, the network node 110 may determine the groupings of the transmission streams (e.g., into the first subset of transmission streams that is grouped with the first subset of the antennas of the UE 120 and into the second subset of transmission streams that is grouped with the second subset of the antennas of the UE 120).

In one example, the network node 110 may determine the groupings based on the correlation between antennas within a subset. For example, the network node 110 may determine the precoder configuration (and the groupings associated with the precoder configuration) based on the precoder configuration resulting in decreased correlation between antennas within a same subset. By selecting a precoder p that minimizes a correlation between antennas within a same subset, the network node 110 may increase a capacity of the channel (e.g., as compared to a channel that is encoded using a precoder that is associated with larger correlations between antennas within the same subset). A precoder configuration that results in zero correlation between the equations of Equation 4 (e.g., the orthogonal rows) associated with the precoded channel may correspond to a precoder configuration where the antennas within a subset have no correlation. A precoder configuration that results in equations (e.g., the rows) associated with the precoded channel that are dependent, and accordingly results in an equations system that is not solvable. However, it is unlikely that a precoder configuration exists that either results in zero correlation or in dependent equations.

In another example, the network node 110 may determine the groupings based on the singular values of the matrices representing the equations system of the channel. Here, the network node 110 may investigate a condition number, which may correspond to a ratio of a highest and lowest singular value of the matrix that represents an equations system associated with the channel. Then, the network node 110 may select the groupings according to a lowest condition number associated with the condition numbers associated with all of the possible groupings. In some cases, selecting the groupings (that is, selecting a precoder configuration) that is associated with the condition number that is the lowest may result in the network node 110 determining a precoder configuration that has a relatively low correlation between antennas within a subset.

Additionally, or alternatively, the network node 110 may determine the groupings based on a capacity function of the precoder C(p), as defined below with reference to Equation 13.

$$C ( p ) = {\sum }_{k ∈ B W} {log}_{2} \vert {I}_{Nss \times Nss} + {( {H}_{k} {p}_{k} )}^{H} {R}_{n n}^{- 1} ( {H}_{k} {p}_{k} ) \vert \qquad ( 13 )$$

The capacity function may be based on a function of the precoder p. In equation 13, I is the identity matrix, Nₛₛ is the quantity of transmission streams, Rₙₙ is an autocovariance matrix associated with the downlink channel between the network node 110 and the UE 120, and Hₖ is the channel at the kth resource element (which may be known to both the network node 110 and the UE 120). In some cases, the network node 110 may determine Rₙₙ based on the UE antenna information. For example, the network node 110 may determine Rₙₙ based on the UE 120 indicating, within the UE antenna information, the noise autocovariance matrix Rₙₙ. Accordingly, the capacity function may sum the capacities at all of the resource elements within a bandwidth associated with the communication from the network node 110 to the UE 120.

In some cases, the network node 110 may determine the capacity of each possible precoded channel based on all of the grouping possibilities. In some cases, the network node 110 may refrain from calculating the channel capacity of one or more grouping possibilities that are associated with a degraded performance (e.g., groupings that are associated with a high correlation between antennas within a subset).

As shown by reference number 330, the network node 110 may transmit, and the UE 120 may receive, configuration information. The configuration information may indicate the groupings associated with the determined precoder configuration. That is, as described regarding reference number 325, the network node 110 may dynamically determine precoder groupings (of subsets of transmission streams with subsets of antennas at the UE 120), for example, based on channel conditions, a capability or configuration of the UE 120, antenna correlation information associated with the antennas at the UE 120, and a capacity of the channel. Based on determining the precoder configuration, the network node 110 may transmit signaling indicating the configuration information.

The configuration information may indicate, to the UE 120, a first grouping of a first subset of a plurality of transmission streams included in a communication with a first subset of the antennas at the UE 120. The configuration information may also indicate a second grouping of a second subset of the plurality of transmission streams with a second subset of the antennas at the UE 120. The first and second subsets of the antennas may be disjoint (e.g., may not include any of the same antennas) and, when combined, may include all of the antennas at the UE 120 that is configured to receive the downlink communication. That is, the first and second subsets of the antennas may collectively encompass all of the antennas at the UE 120 that are configured to receive the communication. Additionally, the first and second subsets of the transmission streams may be disjoint (e.g., may not include any of the same transmission streams) and may, when combined, include all of the transmission streams that is include in the communication. That is, the first and second subsets of the transmission streams may collectively encompass all of the transmission streams.

In some cases, the configuration information may indicate the groupings based on indicating a grouping combination index. For example, the configuration information may indicate a grouping combination index of transmission streams {2, 3, 4, 6} being grouped with antennas {1, 2, 3, 8}, and of transmission streams {1, 5, 7, 8} being grouped with antennas {4, 5, 6, 7}. In this example, the first grouping may correspond to a first subset of the plurality of transmission streams including transmission streams that are associated with the indices 2, 3, 4, and 6, with a first subset of the antennas at the UE including the antennas associated with the indices 1, 2, 3, and 8. Additionally, the second grouping may correspond to a second subset of the plurality of transmission streams including transmission streams that are associated with the indices 1, 5, 7, and 8, with a second subset of the antennas at the UE including antennas that are associated with the indices 4, 5, 6, and 7.

As shown by reference number 335, the network node 110 may transmit, and the UE 120 may receive, an indication to operate in a split precoder mode. In some cases, the network node 110 may transmit the indication for the UE 120 to operate in the split precoder mode based on determining that the UE capability information indicates that the quantity of transmission streams that the UE 120 is capable of demodulating, or configured to demodulate, concurrently is less than a quantity of transmission streams to be used for a communication to the UE 120. In some cases, the indication to operate in the split precoder mode may include an indication of a slot (or another resource in the time domain) when the network node 110 begins precoding communications using an OSP (e.g., a split precoder that divides the channel into multiple sub-channels that the UE 120 may demodulate independently).

As shown by reference number 340, the UE 120 may switch to operating in the split precoder mode. The UE 120 may switch to operating in the split precoder mode based on receiving the indication to switch to the split precoder mode. In some cases, switching to the split precoder mode may include the UE 120 demodulating communications received while operating in the split precoder mode using multiple different independent demodulation operations (e.g., as described regarding reference numbers 355 and 360). The UE 120 may begin operating in the split precoder mode after the time indicated by the network node (e.g., within the indication to operate in the split precoder mode).

As shown by reference number 345, the network node 110 may transmit, and the UE 120 may receive, a communication including a plurality of transmission streams. That is, the network node 110 may apply a precoder (such as an OSP) to a signal to generate the communication.

As shown by reference number 350, the UE 120 may perform one or more channel estimations. In some cases, the UE 120 may perform separate channel estimations on each group indicated by the configuration information. For example, the UE 120 may perform a first channel estimation associated with a first subset of the transmission streams based on the signals detected by the first subset of the antennas at the UE 120. Additionally, the UE 120 may perform a second channel estimation associated with a second subset of the transmission streams based on the signals detected by the second subset of the antennas at the UE 120.

As shown by reference numbers 355 and 360, the UE 120 may perform two lower-order demodulation operations on the communication. That is, the UE 120 may perform de-grouping of the communication where the UE 120 matches each demodulator output of each group of antennas (e.g., each subset of antennas) to each group of transmission streams, in accordance with the configuration information. For example, if the configuration information indicates that the transmission streams {2, 3, 4, 6} are grouped with antennas {1, 2, 3, 8}, and that the transmission streams {1, 5, 7, 8} are grouped with antennas {4, 5, 6, 7}, the UE 120 may match the demodulator output of the antenna group {1, 2, 3, 8} with the transmission streams {2, 3, 4, 6} and may match the demodulator output of the antenna group {4, 5, 6, 7} with the transmission streams {1, 5, 7, 8}.

In particular, and as shown by reference number 355, the UE 120 may demodulate the first subset of transmission streams. That is, the UE 120 may demodulate the first subset of transmission streams of the communication received by the first subset of the antennas at the UE 120. Additionally, and as shown by reference number 360, the UE 120 may demodulate the second subset of transmission streams. That is, the UE 120 may demodulate the first subset of transmission streams of the communication received by the first subset of the antennas at the UE 120.

As indicated above, FIG. 3 is provided as an example. Other examples may differ from what is described with respect to FIG. 3.

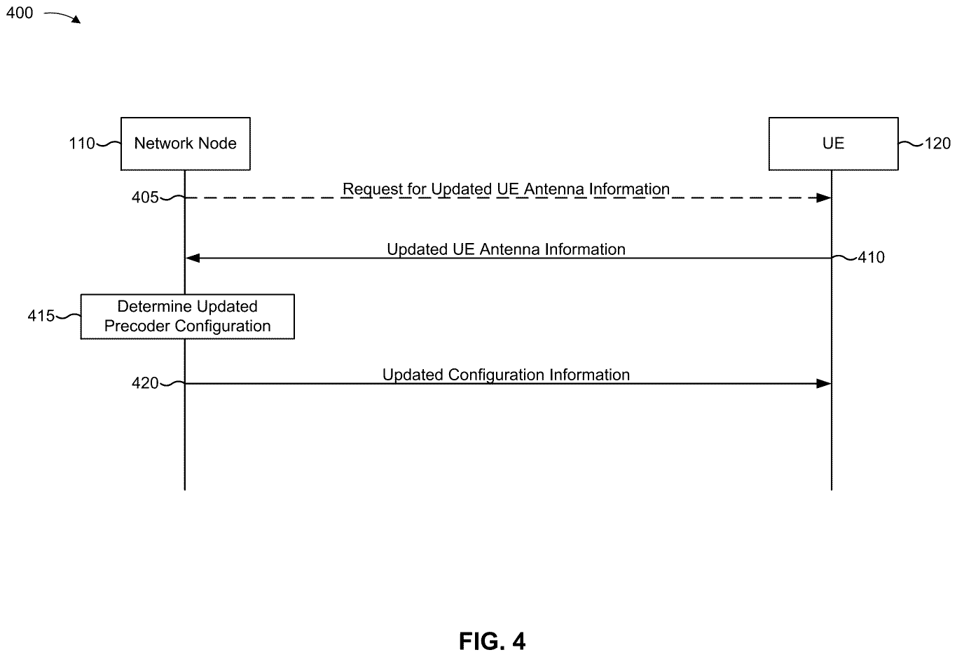

FIG. 4 is a diagram illustrating an example 400 associated with dynamic precoder groupings. As shown in FIG. 4, a network node 110 and a UE 120 may communicate with one another. The example 400 may be associated with the network node 110 updating a precoder configuration or precoder grouping. For example, a network node 110 and a UE 120 may perform the operations described with reference to FIG. 3, and may subsequently perform one or more of the operations described with reference to FIG. 4 to update the dynamic precoder groupings.

As shown by reference number 405, the network node 110 may optionally transmit, and the UE 120 may receive, a request for updated UE antenna information.

As shown by reference number 410, the UE 120 may transmit updated UE antenna information. In some cases, the UE 120 may transmit the updated UE antenna information based on receiving the request from the network node 110. In some other cases (e.g., when the network node 110 does not transmit the request), the UE 120 may transmit the updated UE antenna information based on one or more properties at the UE 120 changing. That is, the UE 120 may transmit the updated UE antenna information if any properties associated with the UE antenna information change. For example, if the UE 120 changes the antenna panels being used, a polarization of any of the antennas, etc., the UE 120 may transmit the updated UE antenna information to the network node 110.

As shown by reference number 415, the network node 110 may determine an updated precoder configuration. In some cases, the network node 110 may determine the updated precoder configuration periodically. For example, the network node 110 may determine the updated precoder configuration at a same rate as channel report updates (e.g., at a same rate as the UE 120 provides updates to a channel report). In some other cases, the network node 110 may configure a periodicity or trigger for updating the precoder configuration. For example, the network node 110 may update the precoder configuration at an order of the Doppler rate, which may correspond to a rate at which the channel changes.

In some cases, the network node 110 may update the precoder configuration to a default precoder configuration. That is, instead of dynamically determining the precoder, the network node 110 may instead set the precoder configuration to a default (for example) and disable an optimization of the groupings based on the channel capacity. In some cases, the network node 110 may switch to the default precoder configuration based on latency requirements associated with the communications between the network node 110 and the UE 120.

As shown by reference number 420, the network node 110 may transmit, and the UE 120 may receive, updated configuration information. The updated configuration information may indicate an update to the first grouping and the second grouping.

After the network node 110 transmits the updated configuration information, the network node 110 and the UE 120 may communicate in accordance with the updated configuration information (e.g., as described regarding reference numbers 345, 350, 355, and 360).

As indicated above, FIG. 4 is provided as an example. Other examples may differ from what is described with respect to FIG. 4.

FIG. 5 is a diagram illustrating an example process 500 performed, for example, at a UE or an apparatus of a UE. Example process 500 is an example where the apparatus or the UE (e.g., UE 120) performs operations associated with dynamic precoder groupings.

As shown in FIG. 5, in some aspects, process 500 may include receiving configuration information indicating a first grouping of a first subset of a plurality of transmission streams with a first subset of a plurality of antennas at the UE and a second grouping of a second subset of the plurality of transmission streams with a second subset of the plurality of antennas (block 510). For example, the UE (e.g., using reception component 702 or communication manager 706, depicted in FIG. 7) may receive configuration information indicating a first grouping of a first subset of a plurality of transmission streams with a first subset of a plurality of antennas at the UE and a second grouping of a second subset of the plurality of transmission streams with a second subset of the plurality of antennas, as described above.

As further shown in FIG. 5, in some aspects, process 500 may include receiving a communication via the plurality of transmission streams (block 520). For example, the UE (e.g., using reception component 702 or communication manager 706, depicted in FIG. 7) may receive a communication via the plurality of transmission streams, as described above.

As further shown in FIG. 5, in some aspects, process 500 may include demodulating the first subset of the plurality of transmission streams received by the first subset of the antennas based at least in part on the configuration information (block 530). For example, the UE (e.g., using communication manager 706, depicted in FIG. 7) may demodulate the first subset of the plurality of transmission streams received by the first subset of the antennas based at least in part on the configuration information, as described above.

As further shown in FIG. 5, in some aspects, process 500 may include demodulating the second subset of the plurality of transmission streams received by the second subset of the antennas based at least in part on the configuration information (block 540). For example, the UE (e.g., using communication manager 706, depicted in FIG. 7) may demodulate the second subset of the plurality of transmission streams received by the second subset of the antennas based at least in part on the configuration information, as described above.

Process 500 may include additional aspects, such as any single aspect or any combination of aspects described below or in connection with one or more other processes described elsewhere herein.

In a first aspect, process 500 includes transmitting, to the network node, UE capability information indicative of a first quantity of transmission streams that the UE is capable of demodulating concurrently.

In a second aspect, alone or in combination with the first aspect, process 500 includes receiving, from the network node, a request for the UE capability information, wherein transmitting the UE capability information is based at least in part on receiving the request.

In a third aspect, alone or in combination with one or more of the first and second aspects, the request is received via a MAC-CE.

In a fourth aspect, alone or in combination with one or more of the first through third aspects, process 500 includes the first subset of the plurality of transmission streams includes a second quantity of transmission streams that is less than or equal to the first quantity, and the second subset of the plurality of transmission streams includes a third quantity of transmission streams that is less than or equal to the first quantity.

In a fifth aspect, alone or in combination with one or more of the first through fourth aspects, the UE capability information is transmitted via a MAC-CE.

In a sixth aspect, alone or in combination with one or more of the first through fifth aspects, process 500 includes receiving, from the network node, an indication to operate in a split precoder mode, wherein demodulating the first subset of the plurality of transmission streams and demodulating the second subset of the plurality of transmission streams are based at least in part on operating in the split precoder mode.

In a seventh aspect, alone or in combination with one or more of the first through sixth aspects, the indication further comprises an indication of a time associated with beginning the operation in the split precoder mode, and process 500 includes switching an operation of the UE from a single precoder mode to a split precoder mode prior to the time associated with beginning the operation in the split precoder mode.

In an eighth aspect, alone or in combination with one or more of the first through seventh aspects, process 500 includes transmitting, to the network node, signaling indicating information associated with the plurality of antennas at the UE, wherein receiving the configuration information is based at least in part on transmitting the signaling.

In a ninth aspect, alone or in combination with one or more of the first through eighth aspects, process 500 includes receiving, from the network node, a request for the information associated with the plurality of antennas at the UE, wherein transmitting the signaling is based at least in part on receiving the request.

In a tenth aspect, alone or in combination with one or more of the first through ninth aspects, the information comprises one or more antenna correlation values associated with the plurality of antennas or an autocovariance matrix associated with the plurality of antennas.

In an eleventh aspect, alone or in combination with one or more of the first through tenth aspects, process 500 includes performing a first channel estimation associated with the first subset of the plurality of transmission streams based at least in part on one or more signals detected by the first subset of the plurality of antennas, wherein demodulating the first subset of the plurality of transmission streams is based at least in part on performing the first channel estimation, and performing a second channel estimation associated with the second subset of the plurality of transmission streams based at least in part on one or more signals detected by the second subset of the plurality of antennas, wherein demodulating the second subset of the plurality of transmission streams is based at least in part on performing the second channel estimation.

In a twelfth aspect, alone or in combination with one or more of the first through eleventh aspects, the first subset of the plurality of transmission streams and the second subset of the plurality of transmission streams are disjoint and collectively encompass each transmission stream of the plurality of transmission streams.

Although FIG. 5 shows example blocks of process 500, in some aspects, process 500 may include additional blocks, fewer blocks, different blocks, or differently arranged blocks than those depicted in FIG. 5. Additionally, or alternatively, two or more of the blocks of process 500 may be performed in parallel.

FIG. 6 is a diagram illustrating an example process 600 performed, for example, at a network node or an apparatus of a network node. Example process 600 is an example where the apparatus or the network node (e.g., network node 110) performs operations associated with dynamic precoder groupings.

As shown in FIG. 6, in some aspects, process 600 may include transmitting, to a UE, configuration information indicating a first grouping of a first subset of a plurality of transmission streams with a first subset of a plurality of antennas at the UE and a second grouping of a second subset of the plurality of transmission streams with a second subset of the plurality of antennas (block 610). For example, the network node (e.g., using transmission component 804 or communication manager 806, depicted in FIG. 8) may transmit, to a UE, configuration information indicating a first grouping of a first subset of a plurality of transmission streams with a first subset of a plurality of antennas at the UE and a second grouping of a second subset of the plurality of transmission streams with a second subset of the plurality of antennas, as described above.

As further shown in FIG. 6, in some aspects, process 600 may include applying a precoder to a signal to generate a communication in accordance with the configuration information (block 620). For example, the network node (e.g., using communication manager 806, depicted in FIG. 8) may apply a precoder to a signal to generate a communication in accordance with the configuration information, as described above.

As further shown in FIG. 6, in some aspects, process 600 may include transmitting, to the UE using the plurality of antennas, the communication via the plurality of transmission streams (block 630). For example, the network node (e.g., using transmission component 804 or communication manager 806, depicted in FIG. 8) may transmit, to the UE using the plurality of antennas, the communication via the plurality of transmission streams, as described above.

Process 600 may include additional aspects, such as any single aspect or any combination of aspects described below or in connection with one or more other processes described elsewhere herein.

In a first aspect, process 600 includes receiving, from the UE, UE capability information indicative of a first quantity of transmission streams that the UE is capable of demodulating concurrently.

In a second aspect, alone or in combination with the first aspect, process 600 includes transmitting, to the UE, a request for the UE capability information, wherein receiving the UE capability information is based at least in part on transmitting the request.

In a third aspect, alone or in combination with one or more of the first and second aspects, the request is transmitted via a MAC-CE.

In a fourth aspect, alone or in combination with one or more of the first through third aspects, process 600 includes the first subset of the plurality of transmission streams includes a second quantity of transmission streams that is less than or equal to the first quantity, and the second subset of the plurality of transmission streams includes a third quantity of transmission streams that is less than or equal to the first quantity.

In a fifth aspect, alone or in combination with one or more of the first through fourth aspects, the UE capability information is received via a MAC-CE.

In a sixth aspect, alone or in combination with one or more of the first through fifth aspects, process 600 includes transmitting, to the UE, an indication to operate in a split precoder mode.

In a seventh aspect, alone or in combination with one or more of the first through sixth aspects, the indication further comprises an indication of a time associated with beginning the operation in the split precoder mode.

In an eighth aspect, alone or in combination with one or more of the first through seventh aspects, process 600 includes receiving, from the UE, signaling indicating information associated with the plurality of antennas at the UE, wherein transmitting the configuration information is based at least in part on receiving the signaling.

In a ninth aspect, alone or in combination with one or more of the first through eighth aspects, process 600 includes transmitting, to the UE, a request for the information associated with the plurality of antennas at the UE.

In a tenth aspect, alone or in combination with one or more of the first through ninth aspects, the information comprises one or more antenna correlation values associated with the plurality of antennas or an autocovariance matrix associated with the plurality of antennas.

In an eleventh aspect, alone or in combination with one or more of the first through tenth aspects, the first subset of the plurality of transmission streams and the second subset of the plurality of transmission streams are disjoint and collectively encompass each transmission stream of the plurality of transmission streams.

Although FIG. 6 shows example blocks of process 600, in some aspects, process 600 may include additional blocks, fewer blocks, different blocks, or differently arranged blocks than those depicted in FIG. 6. Additionally, or alternatively, two or more of the blocks of process 600 may be performed in parallel.

FIG. 7 is a diagram of an example apparatus 700 for wireless communication. The apparatus 700 may be a UE, or a UE may include the apparatus 700. In some aspects, the apparatus 700 includes a reception component 702, a transmission component 704, or a communication manager 706, which may be in communication with one another (for example, via one or more buses or one or more other components). In some aspects, the communication manager 706 is the communication manager 150 described in connection with FIG. 1. As shown, the apparatus 700 may communicate with another apparatus 708, such as a UE or a network node (such as a CU, a DU, an RU, or a base station), using the reception component 702 and the transmission component 704. The communication manager 706 may be included in, or implemented via, a processing system (for example, the processing system 140 described in connection with FIG. 1) of the UE.

In some aspects, the apparatus 700 may be configured to perform one or more operations described herein in connection with FIGS. 2A-4. Additionally, or alternatively, the apparatus 700 may be configured to perform one or more processes described herein, such as process 500 of FIG. 5. In some aspects, the apparatus 700 or one or more components shown in FIG. 7 may include one or more components of the UE described in connection with FIG. 1. Additionally, or alternatively, one or more components shown in FIG. 7 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 702 may receive communications, such as reference signals, control information, data communications, or a combination thereof, from the apparatus 708. The reception component 702 may provide received communications to one or more other components of the apparatus 700. In some aspects, the reception component 702 may perform signal processing on the received communications, and may provide the processed signals to the one or more other components of the apparatus 700. In some aspects, the reception component 702 may include one or more components of the UE described above in connection with FIG. 1, such as a radio, one or more RF chains, one or more transceivers, or one or more modems, each of which may in turn be coupled with one or more antennas of the UE.

The transmission component 704 may transmit communications, such as reference signals, control information, data communications, or a combination thereof, to the apparatus 708. In some aspects, one or more other components of the apparatus 700 may generate communications and may provide the generated communications to the transmission component 704 for transmission to the apparatus 708. In some aspects, the transmission component 704 may perform signal processing on the generated communications, and may transmit the processed signals to the apparatus 708. In some aspects, the transmission component 704 may include one or more components of the UE described above in connection with FIG. 1, such as a radio, one or more RF chains, one or more transceivers, or one or more modems, each of which may in turn be coupled with one or more antennas of the UE described in connection with FIG. 1. In some aspects, the transmission component 704 may be co-located with the reception component 702.

The communication manager 706 may support operations of the reception component 702 or the transmission component 704. For example, the communication manager 706 may receive information associated with configuring reception of communications by the reception component 702 or transmission of communications by the transmission component 704. Additionally, or alternatively, the communication manager 706 may generate or provide control information to the reception component 702 or the transmission component 704 to control reception or transmission of communications.

The reception component 702 may receive, from a network node, configuration information indicating a first grouping of a first subset of a plurality of transmission streams with a first subset of a plurality of antennas at the UE and a second grouping of a second subset of the plurality of transmission streams with a second subset of the plurality of antennas. The reception component 702 may receive, from the network node using the plurality of antennas, a communication via the plurality of transmission streams. The communication manager 706 may demodulate the first subset of the plurality of transmission streams received by the first subset of the antennas based at least in part on the configuration information. The communication manager 706 may demodulate the second subset of the plurality of transmission streams received by the second subset of the antennas based at least in part on the configuration information.

The transmission component 704 may transmit, to the network node, UE capability information indicative of a first quantity of transmission streams that the UE is capable of demodulating concurrently.

The reception component 702 may receive, from the network node, a request for the UE capability information, wherein transmitting the UE capability information is based at least in part on receiving the request.

The reception component 702 may receive, from the network node, an indication to operate in a split precoder mode, wherein demodulating the first subset of the plurality of transmission streams and demodulating the second subset of the plurality of transmission streams are based at least in part on operating in the split precoder mode.

The transmission component 704 may transmit, to the network node, signaling indicating information associated with the plurality of antennas at the UE, wherein receiving the configuration information is based at least in part on transmitting the signaling.

The reception component 702 may receive, from the network node, a request for the information associated with the plurality of antennas at the UE, wherein transmitting the signaling is based at least in part on receiving the request.

The communication manager 706 may perform a first channel estimation associated with the first subset of the plurality of transmission streams based at least in part on one or more signals detected by the first subset of the plurality of antennas, wherein demodulating the first subset of the plurality of transmission streams is based at least in part on performing the first channel estimation.

The communication manager 706 may perform a second channel estimation associated with the second subset of the plurality of transmission streams based at least in part on one or more signals detected by the second subset of the plurality of antennas, wherein demodulating the second subset of the plurality of transmission streams is based at least in part on performing the second channel estimation.

The number and arrangement of components shown in FIG. 7 are provided as an example. In practice, there may be additional components, fewer components, different components, or differently arranged components than those shown in FIG. 7. Furthermore, two or more components shown in FIG. 7 may be implemented within a single component, or a single component shown in FIG. 7 may be implemented as multiple, distributed components. Additionally, or alternatively, a set of (one or more) components shown in FIG. 7 may perform one or more functions described as being performed by another set of components shown in FIG. 7.

FIG. 8 is a diagram of an example apparatus 800 for wireless communication. The apparatus 800 may be a network node, or a network node may include the apparatus 800. In some aspects, the apparatus 800 includes a reception component 802, a transmission component 804, or a communication manager 806, which may be in communication with one another (for example, via one or more buses or one or more other components). In some aspects, the communication manager 806 is the communication manager 155 described in connection with FIG. 1. As shown, the apparatus 800 may communicate with another apparatus 808, such as a UE or a network node (such as a CU, a DU, an RU, or a base station), using the reception component 802 and the transmission component 804. The communication manager 806 may be included in, or implemented via, a processing system (for example, the processing system 145 described in connection with FIG. 1) of the network node.

In some aspects, the apparatus 800 may be configured to perform one or more operations described herein in connection with FIGS. 2A-4. Additionally, or alternatively, the apparatus 800 may be configured to perform one or more processes described herein, such as process 600 of FIG. 6. In some aspects, the apparatus 800 or one or more components shown in FIG. 8 may include one or more components of the network node described in connection with FIG. 1. Additionally, or alternatively, one or more components shown in FIG. 8 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 802 may receive communications, such as reference signals, control information, data communications, or a combination thereof, from the apparatus 808. The reception component 802 may provide received communications to one or more other components of the apparatus 800. In some aspects, the reception component 802 may perform signal processing on the received communications, and may provide the processed signals to the one or more other components of the apparatus 800. In some aspects, the reception component 802 may include one or more components of the network node described above in connection with FIG. 1, such as a radio, one or more RF chains, one or more transceivers, or one or more modems, each of which may in turn be coupled with one or more antennas of the network node. In some aspects, the reception component 802 or the transmission component 804 may include or may be included in a network interface. The network interface may be configured to obtain or output signals for the apparatus 800 via one or more communications links, such as a backhaul link, a midhaul link, or a fronthaul link.

The transmission component 804 may transmit communications, such as reference signals, control information, data communications, or a combination thereof, to the apparatus 808. In some aspects, one or more other components of the apparatus 800 may generate communications and may provide the generated communications to the transmission component 804 for transmission to the apparatus 808. In some aspects, the transmission component 804 may perform signal processing on the generated communications, and may transmit the processed signals to the apparatus 808. In some aspects, the transmission component 804 may include one or more components of the network node described above in connection with FIG. 1, such as a radio, one or more RF chains, one or more transceivers, or one or more modems, each of which may in turn be coupled with one or more antennas of the network node described in connection with FIG. 1. In some aspects, the transmission component 804 may be co-located with the reception component 802.

The communication manager 806 may support operations of the reception component 802 or the transmission component 804. For example, the communication manager 806 may receive information associated with configuring reception of communications by the reception component 802 or transmission of communications by the transmission component 804. Additionally, or alternatively, the communication manager 806 may generate or provide control information to the reception component 802 or the transmission component 804 to control reception or transmission of communications.

The transmission component 804 may transmit, to a UE, configuration information indicating a first grouping of a first subset of a plurality of transmission streams with a first subset of a plurality of antennas at the UE and a second grouping of a second subset of the plurality of transmission streams with a second subset of the plurality of antennas. The communication manager 806 may apply a precoder to a signal to generate a communication in accordance with the configuration information.

The transmission component 804 may transmit, to the UE using the plurality of antennas, the communication via the plurality of transmission streams.

The reception component 802 may receive, from the UE, UE capability information indicative of a first quantity of transmission streams that the UE is capable of demodulating concurrently.

The transmission component 804 may transmit, to the UE, a request for the UE capability information, wherein receiving the UE capability information is based at least in part on transmitting the request.

The transmission component 804 may transmit, to the UE, an indication to operate in a split precoder mode.

The reception component 802 may receive, from the UE, signaling indicating information associated with the plurality of antennas at the UE, wherein transmitting the configuration information is based at least in part on receiving the signaling.

The transmission component 804 may transmit, to the UE, a request for the information associated with the plurality of antennas at the UE.

The number and arrangement of components shown in FIG. 8 are provided as an example. In practice, there may be additional components, fewer components, different components, or differently arranged components than those shown in FIG. 8. Furthermore, two or more components shown in FIG. 8 may be implemented within a single component, or a single component shown in FIG. 8 may be implemented as multiple, distributed components. Additionally, or alternatively, a set of (one or more) components shown in FIG. 8 may perform one or more functions described as being performed by another set of components shown in FIG. 8.

The following provides an overview of some Aspects of the present disclosure:

Aspect 1: A method of wireless communication performed by a UE, comprising: receiving, from a network node, configuration information indicating a first grouping of a first subset of a plurality of transmission streams with a first subset of a plurality of antennas at the UE and a second grouping of a second subset of the plurality of transmission streams with a second subset of the plurality of antennas; receiving, from the network node using the plurality of antennas, a communication via the plurality of transmission streams; demodulating the first subset of the plurality of transmission streams received by the first subset of the antennas based at least in part on the configuration information; and demodulating the second subset of the plurality of transmission streams received by the second subset of the antennas based at least in part on the configuration information.

Aspect 2: The method of Aspect 1, further comprising: transmitting, to the network node, UE capability information indicative of a first quantity of transmission streams that the UE is capable of demodulating concurrently.

Aspect 3: The method of Aspect 2, further comprising: receiving, from the network node, a request for the UE capability information, wherein transmitting the UE capability information is based at least in part on receiving the request.

Aspect 4: The method of Aspect 3, wherein the request is received via a MAC-CE.

Aspect 5: The method of Aspect 2, wherein: the first subset of the plurality of transmission streams includes a second quantity of transmission streams that is less than or equal to the first quantity; and the second subset of the plurality of transmission streams includes a third quantity of transmission streams that is less than or equal to the first quantity.

Aspect 6: The method of Aspect 2, wherein the UE capability information is transmitted via a MAC-CE.

Aspect 7: The method of any of Aspects 1-6, further comprising: receiving, from the network node, an indication to operate in a split precoder mode, wherein demodulating the first subset of the plurality of transmission streams and demodulating the second subset of the plurality of transmission streams are based at least in part on operating in the split precoder mode.

Aspect 8: The method of Aspect 7, wherein the indication further comprises an indication of a time associated with beginning the operation in the split precoder mode, and wherein the method further comprises: switching an operation of the UE from a single precoder mode to a split precoder mode prior to the time associated with beginning the operation in the split precoder mode.

Aspect 9: The method of any of Aspects 1-8, further comprising: transmitting, to the network node, signaling indicating information associated with the plurality of antennas at the UE, wherein receiving the configuration information is based at least in part on transmitting the signaling.

Aspect 10: The method of Aspect 9, further comprising: receiving, from the network node, a request for the information associated with the plurality of antennas at the UE, wherein transmitting the signaling is based at least in part on receiving the request.

Aspect 11: The method of Aspect 9, wherein the information comprises one or more antenna correlation values associated with the plurality of antennas or an autocovariance matrix associated with the plurality of antennas.

Aspect 12: The method of any of Aspects 1-11, further comprising: performing a first channel estimation associated with the first subset of the plurality of transmission streams based at least in part on one or more signals detected by the first subset of the plurality of antennas, wherein demodulating the first subset of the plurality of transmission streams is based at least in part on performing the first channel estimation; and performing a second channel estimation associated with the second subset of the plurality of transmission streams based at least in part on one or more signals detected by the second subset of the plurality of antennas, wherein demodulating the second subset of the plurality of transmission streams is based at least in part on performing the second channel estimation.

Aspect 13: The method of any of Aspects 1-12, wherein the first subset of the plurality of transmission streams and the second subset of the plurality of transmission streams are disjoint and collectively encompass each transmission stream of the plurality of transmission streams.

Aspect 14: A method of wireless communication performed by a network node, comprising: transmitting, to a UE, configuration information indicating a first grouping of a first subset of a plurality of transmission streams with a first subset of a plurality of antennas at the UE and a second grouping of a second subset of the plurality of transmission streams with a second subset of the plurality of antennas; applying a precoder to a signal to generate a communication in accordance with the configuration information; and transmitting, to the UE using the plurality of antennas, the communication via the plurality of transmission streams.

Aspect 15: The method of Aspect 14, further comprising: receiving, from the UE, UE capability information indicative of a first quantity of transmission streams that the UE is capable of demodulating concurrently.

Aspect 16: The method of Aspect 15, further comprising: transmitting, to the UE, a request for the UE capability information, wherein receiving the UE capability information is based at least in part on transmitting the request.

Aspect 17: The method of Aspect 16, wherein the request is transmitted via a MAC-CE.

Aspect 18: The method of Aspect 15, wherein: the first subset of the plurality of transmission streams includes a second quantity of transmission streams that is less than or equal to the first quantity; and the second subset of the plurality of transmission streams includes a third quantity of transmission streams that is less than or equal to the first quantity.

Aspect 19: The method of Aspect 15, wherein the UE capability information is received via a MAC-CE.

Aspect 20: The method of any of Aspects 14-19, further comprising: transmitting, to the UE, an indication to operate in a split precoder mode.

Aspect 21: The method of Aspect 20, wherein the indication further comprises an indication of a time associated with beginning the operation in the split precoder mode.

Aspect 22: The method of any of Aspects 14-21, further comprising: receiving, from the UE, signaling indicating information associated with the plurality of antennas at the UE, wherein transmitting the configuration information is based at least in part on receiving the signaling.

Aspect 23: The method of Aspect 22, further comprising: transmitting, to the UE, a request for the information associated with the plurality of antennas at the UE.

Aspect 24: The method of Aspect 22, wherein the information comprises one or more antenna correlation values associated with the plurality of antennas or an autocovariance matrix associated with the plurality of antennas.

Aspect 25: The method of any of Aspects 14-24, wherein the first subset of the plurality of transmission streams and the second subset of the plurality of transmission streams are disjoint and collectively encompass each transmission stream of the plurality of transmission streams.

Aspect 26: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-25.

Aspect 27: An apparatus for wireless communication at a device, the apparatus comprising one or more memories and one or more processors coupled to the one or more memories, the one or more processors configured to cause the device to perform the method of one or more of Aspects 1-25.

Aspect 28: An apparatus for wireless communication, the apparatus comprising at least one means for performing the method of one or more of Aspects 1-25.

Aspect 29: A non-transitory computer-readable medium storing code for wireless communication, the code comprising instructions executable by one or more processors to perform the method of one or more of Aspects 1-25.

Aspect 30: A non-transitory computer-readable medium storing a set of instructions for wireless communication, the set of instructions comprising one or more instructions that, when executed by one or more processors of a device, cause the device to perform the method of one or more of Aspects 1-25.

Aspect 31: A device for wireless communication, the device comprising a processing system that includes one or more processors and one or more memories coupled with the one or more processors, the processing system configured to cause the device to perform the method of one or more of Aspects 1-25.

Aspect 32: An apparatus for wireless communication at a device, the apparatus comprising one or more memories and one or more processors coupled to the one or more memories, the one or more processors individually or collectively configured to cause the device to perform the method of one or more of Aspects 1-25.

Aspect 33: A device comprising a processing system that includes one or more processors and one or more code-storing memories coupled with the one or more processors, the processing system configured to cause the device to perform the method of one or more of Aspects 1-25.

Aspect 34: A device comprising a processing system that includes processor circuitry and code-storing memory circuitry, the processing system configured to cause the device to perform the method of one or more of Aspects 1-25.

It will be apparent that systems or methods described herein may be implemented in different forms of hardware or a combination of hardware and software. A component being configured to perform a function means that the component has a capability to perform the function, and does not require the function to be actually performed by the component, unless noted otherwise.

As used herein, the term “determine” or “determining” can encompass one or more of a wide variety of actions. For example, “determining” can include one or more of calculating, computing, processing, deriving, detecting, estimating, investigating, looking up, inferring, ascertaining, measuring, resolving, selecting, choosing, obtaining, identifying, interpreting, demodulating, decoding, reading, establishing, forming or generating, among other examples. In some such examples, determining can involve a processor performing some type of calculating, computing, deriving, estimating, inferring, ascertaining, resolving, predicting or other processing to obtain one or more numerical values, sets, elements or other information or results. In some other such examples, determining can involve a processor identifying, looking up, investigating or otherwise obtaining some type of value, set, element or other information or result from a table, a data structure, a database or other memory device or location. In some other such examples, determining can involve a processor identifying, interpreting, demodulating, decoding, detecting, reading or otherwise obtaining some type of value, set, element or other information or result signaled in, for example, a received wireless packet. In some other such examples, determining can involve a processor selecting or choosing one or more values, sets, elements or other information or results from a larger set of values, sets elements or other information or results. In some other such examples, determining can involve a processor performing a measurement, such as on a received signal.

As used herein, the articles “a” and “an” are intended to refer to one or more items and may be used interchangeably with “one or more” or “at least one.” As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. Additionally, as used herein, a phrase referring to “a” or “an” element refers to one or more of such elements acting individually or collectively to perform the recited function(s). Additionally, as used herein, a “set” can refer to one or more items, and a “subset” can refer to a whole set or less than the whole set, but not an empty set. “Set,” “group,” and similar terms are intended to include one or more items and may be used interchangeably with “one or more.” Furthermore, as used herein, the term “or” is intended to be interpreted in the inclusive sense (such as when referring to a series) and may be used interchangeably with “and/or,” unless otherwise explicitly indicated (for example, if used in conjunction with “either” or “only one of”). For example, “A or B” may include A only, B only, or a combination of A and B. Also, as used herein, the terms “has,” “have,” “having,” “comprise,” “comprising,” “include” and “including,” and derivatives thereof or similar terms are intended to be open-ended terms that do not limit an element that they modify (for example, an element “having” A also may have B).

As used herein, the phrase “associated with” is intended to be interpreted in the inclusive sense, unless otherwise explicitly indicated. For example, the phrase “associated with” is not to be construed as a reference to a closed set of conditions, factors, criteria, elements, components, or actions, among other examples. Specifically, unless a phrase refers to “associated with only ‘a,’” or the equivalent in context, whatever it is that is “associated with ‘a,’” may be associated with “a” alone or associated with a combination of “a” and one or more other conditions, factors, criteria, elements, components, or actions, among other examples. In various examples, the phrase “associated with” may be interpreted to mean “in association with,” “in accordance with,” “based on,” “based at least in part on,” “as a function of,” “in response to,” “responsive to,” or “using” as appropriate in the relevant context unless otherwise explicitly indicated. Furthermore, what follows the phrase “associated with,” “in association with,” “in accordance with,” “based on,” “based at least in part on,” “as a function of,” “in response to,” “responsive to,” or “using” is not necessarily the focal point or primary factor associated with the limitation preceding the phrase.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. A user equipment (UE), comprising:
a processing system that includes one or more processors and one or more code-storing memories coupled with the one or more processors, the processing system configured to cause the UE to:
receive, from a network node, configuration information indicating a first grouping of a first subset of a plurality of transmission streams with a first subset of a plurality of antennas at the UE and a second grouping of a second subset of the plurality of transmission streams with a second subset of the plurality of antennas;
receive, from the network node using the plurality of antennas, a communication via the plurality of transmission streams;
demodulate the first subset of the plurality of transmission streams received by the first subset of the antennas based at least in part on the configuration information; and
demodulate the second subset of the plurality of transmission streams received by the second subset of the antennas based at least in part on the configuration information.

2. The UE of claim 1, wherein the processing system is configured to cause the UE to:
transmit, to the network node, UE capability information indicative of a first quantity of transmission streams that the UE is capable of demodulating concurrently.

3. The UE of claim 2, wherein the processing system is configured to cause the UE to:
receive, from the network node, a request for the UE capability information, wherein transmitting the UE capability information is based at least in part on receiving the request.

4. The UE of claim 3, wherein the request is received via a medium access control control element (MAC-CE).

5. The UE of claim 2, wherein:
the first subset of the plurality of transmission streams includes a second quantity of transmission streams that is less than or equal to the first quantity; and
the second subset of the plurality of transmission streams includes a third quantity of transmission streams that is less than or equal to the first quantity.

6. The UE of claim 2, wherein the UE capability information is transmitted via a medium access control control element (MAC-CE).

7. The UE of claim 1, wherein the processing system is configured to cause the UE to:
receive, from the network node, an indication to operate in a split precoder mode, wherein demodulating the first subset of the plurality of transmission streams and demodulating the second subset of the plurality of transmission streams are based at least in part on operating in the split precoder mode.

8. The UE of claim 7, wherein the indication further comprises an indication of a time associated with beginning the operation in the split precoder mode, and wherein the processing system is configured to cause the UE to:
switch an operation of the UE from a single precoder mode to a split precoder mode prior to the time associated with beginning the operation in the split precoder mode.

9. The UE of claim 1, wherein the processing system is configured to cause the UE to:
transmit, to the network node, signaling indicating information associated with the plurality of antennas at the UE, wherein receiving the configuration information is based at least in part on transmitting the signaling.

10. The UE of claim 9, wherein the processing system is configured to cause the UE to:
receive, from the network node, a request for the information associated with the plurality of antennas at the UE, wherein transmitting the signaling is based at least in part on receiving the request.

11. The UE of claim 9, wherein the information comprises one or more antenna correlation values associated with the plurality of antennas or an autocovariance matrix associated with the plurality of antennas.

12. The UE of claim 1, wherein the processing system is configured to cause the UE to:
perform a first channel estimation associated with the first subset of the plurality of transmission streams based at least in part on one or more signals detected by the first subset of the plurality of antennas, wherein demodulating the first subset of the plurality of transmission streams is based at least in part on performing the first channel estimation; and
perform a second channel estimation associated with the second subset of the plurality of transmission streams based at least in part on one or more signals detected by the second subset of the plurality of antennas, wherein demodulating the second subset of the plurality of transmission streams is based at least in part on performing the second channel estimation.

13. The UE of claim 1, wherein the first subset of the plurality of transmission streams and the second subset of the plurality of transmission streams are disjoint and collectively encompass each transmission stream of the plurality of transmission streams.

14. A method of wireless communication performed by a user equipment (UE), comprising:
receiving, from a network node, configuration information indicating a first grouping of a first subset of a plurality of transmission streams with a first subset of a plurality of antennas at the UE and a second grouping of a second subset of the plurality of transmission streams with a second subset of the plurality of antennas;
receiving, from the network node using the plurality of antennas, a communication via the plurality of transmission streams;
demodulating the first subset of the plurality of transmission streams received by the first subset of the antennas based at least in part on the configuration information; and
demodulating the second subset of the plurality of transmission streams received by the second subset of the antennas based at least in part on the configuration information.

15. The method of claim 14, further comprising:
transmitting, to the network node, UE capability information indicative of a first quantity of transmission streams that the UE is capable of demodulating concurrently.

16. The method of claim 15, further comprising:
receiving, from the network node, a request for the UE capability information, wherein transmitting the UE capability information is based at least in part on receiving the request.

17. The method of claim 15, wherein:
the first subset of the plurality of transmission streams includes a second quantity of transmission streams that is less than or equal to the first quantity; and
the second subset of the plurality of transmission streams includes a third quantity of transmission streams that is less than or equal to the first quantity.

18. The method of claim 14, further comprising:
receiving, from the network node, an indication to operate in a split precoder mode, wherein demodulating the first subset of the plurality of transmission streams and demodulating the second subset of the plurality of transmission streams are based at least in part on operating in the split precoder mode.

19. The method of claim 18, wherein the indication further comprises an indication of a time associated with beginning the operation in the split precoder mode, and wherein the method further comprises:
switching an operation of the UE from a single precoder mode to a split precoder mode prior to the time associated with beginning the operation in the split precoder mode.

20. A non-transitory computer-readable medium storing a set of instructions for wireless communication, the set of instructions comprising:
one or more instructions that, when executed by one or more processors of a user equipment (UE), cause the UE to:
receive, from a network node, configuration information indicating a first grouping of a first subset of a plurality of transmission streams with a first subset of a plurality of antennas at the UE and a second grouping of a second subset of the plurality of transmission streams with a second subset of the plurality of antennas;
receive, from the network node using the plurality of antennas, a communication via the plurality of transmission streams;
demodulate the first subset of the plurality of transmission streams received by the first subset of the antennas based at least in part on the configuration information; and
demodulate the second subset of the plurality of transmission streams received by the second subset of the antennas based at least in part on the configuration information.
